(19) United States
(12) Patent Application Publication
(10) Pub. No.: US 2023/0388392 A1
(43) Pub. Date: Nov. 30, 2023

(54) INACTIVITY LOGOFF ADJUSTMENT BASED ON SCHEDULED EVENTS

(71) Applicant: Citrix Systems, Inc., Fort Lauderdale, FL (US)

(72) Inventors: Peng Yao, Nanjing (CN); Lei Zhou, Nanjing (CN); Tianyu Xiao, Nanjing (CN)

(21) Appl. No.: 17/859,336

(22) Filed: Jul. 7, 2022

Related U.S. Application Data
(63) Continuation of application No. PCT/CN2022/095597, filed on May 27, 2022.

(51) Int. Cl. H04L 67/54; G06F 9/54

(52) U.S. Cl. CPC H04L 67/54; G06F 9/546

(57) ABSTRACT

Systems and methods for inactivity logoff adjustment based on scheduled events are provided. A device can include one or more processors, coupled to memory. The device can detect a condition to terminate, at a first timestamp, a computing session established by the one or more processors. The device can identify, responsive to detection of the condition and prior to termination of the computing session, an event for execution in the computing session at a second timestamp subsequent to the first timestamp. The device can provide, based on a difference between the second timestamp and the first timestamp less than or equal to a threshold, a user interface element configured to extend the computing session to at least the second timestamp.

### CROSS-REFERENCE TO RELATED APPLICATION

This application is a continuation of and claims priority to International Application No. PCT/CN2022/095597, titled “INACTIVITY LOGOFF ADJUSTMENT BASED ON SCHEDULED EVENTS,” and filed on May 27, 2022, the contents of all of which are hereby incorporated herein by reference in its entirety for all purposes.

### FIELD OF THE DISCLOSURE

The present application generally relates to managing session connectivity, including but not limited to systems and methods for inactivity logoff adjustment based on scheduled events.

### BACKGROUND

Client devices can establish sessions with one or more servers hosting the sessions. The servers can allocate computing resources to the one or more sessions. Client devices can access resources from the servers via the one or more established sessions.

### SUMMARY

Client devices can establish sessions (e.g., computing sessions) with one or more servers (e.g., physical or virtual servers) to access resources. To establish the session, a client device can transmit a request to establish a session with a server. The client device can receive an authentication request to authenticate the user. The client device can receive inputs from the user to respond to the authentication request, among other subsequent requests to verify the user identity. Upon successfully authenticating the user, the client device can establish the session with the server, thereby gaining access to resources. The server can monitor activities within the session. The session can be configured with a predefined timeout value (e.g., timeout period or duration) configured by the administrator of the session or the server. Subsequent to inactivity of the user for the predefined value, the server may automatically terminate the session or disconnect the client device from the session. The client device can reestablish the session or request a new session by performing the authentication process. However, certain users may have one or more scheduled events (e.g., tasks) following (e.g., within a predetermined duration of) the session termination time. To execute the scheduled event, the client device may reestablish the session connection, which can include handshaking protocols, authentication, or other remote procedure calls. Hence, terminating the session based on the timeout value may lead to incorrect or erroneous session terminations and excessive requests to establish new computing sessions, thereby causing excessive network, processor, or memory utilization.

The systems and methods of this technical solution can detect the inactivity of an established session and determine whether to terminate the session due to inactivity for a predetermined duration or extend the session based on an upcoming event. For example, the systems and methods can include a device including one or more processors coupled to memory. The device can collect or detect events associated with the user, such as calendar events, supported task lists (e.g., including a timer or a scheduled time), among other types of events. The device can detect an inactivity condition and prepare to log off the user or terminate the session. Responsive to detecting the condition, if there is no event satisfying one or more criteria, such as a scheduled event within a predetermined duration (e.g., 15 minutes or 30 minutes) from a timeout period, the device can automatically terminate the session or log off the user at the timeout period. Otherwise, if an event satisfying one or more criteria is detected, the device can notify the user for confirmation to extend the session.

Once confirmation from the user is received, the device can skip at least one logoff sequence to extend the session for the client device. Therefore, by accounting for upcoming events instead of logging off the user according to a predefined timeout value, the device can minimize the reauthentication processes or login attempts, thereby reducing resource consumption (e.g., fewer authentication attempts), reducing network traffic, minimizing latency to access the tasks, and enhancing user experience (e.g., avoid unnecessarily logoff and increase productivity).

An aspect of this disclosure can be directed to a system. The system can include one or more processors, coupled to memory. The one or more processors can detect a condition to terminate, at a first timestamp, a computing session established by the one or more processors. The one or more processors can identify, responsive to detection of the condition and prior to termination of the computing session, an event for execution in the computing session at a second timestamp subsequent to the first timestamp. The one or more processors can provide, based on a difference between the second timestamp and the first timestamp less than or equal to a threshold, a user interface element configured to extend the computing session to at least the second timestamp.

The one or more processors can invoke, responsive to detection of the condition and prior to termination of the computing session, a script configured to access a data structure that maintains a plurality of events to be executed in the computing session at a plurality of timestamps. The data structure can be maintained by the one or more processors.

The data structure may be maintained on one or more servers remote from the one or more processors. The one or more servers can be configured to aggregate the plurality of events from a plurality of client devices comprising a client device of the one or more processors associated with a same account identifier. The one or more processors can determine, based on a keyword of the event, that the computing session executes the event.

The one or more processors can identify a second event at a third timestamp responsive to a second detection of the condition. The one or more processors can determine, based on a keyword of the event, that the second event is not configured for execution in the computing session. The one or more processors can terminate the computing session without provision of the user interface element configured to extend the computing session.

The one or more processors can detect the condition based on a duration of inactivity in the computing session being greater than or equal to a timeout value. The one or more processors can receive, from one or more servers remote from the one or more processors, upon establishment of the computing session with the one or more servers via an authentication handshake process, the timeout value for the computing session. The timeout value can be established by an administrator of the computing session that is different from a user that established the computing session.

The one or more processors can determine, based on a parameter of the event, an amount of time taken to execute the event. The one or more processors can provide the user interface element with a configuration to extend the computing session to at least a third timestamp that is the amount of time taken from the second timestamp. The one or more processors can receive, via the user interface element, an instruction to extend the computing session to the at least the second timestamp. The one or more processors can prevent, responsive to the instruction, termination of the computing session to at least the second timestamp to reduce an occurrence of an authentication process to re-establish the computing session to execute the event.

The one or more processors can initiate a counter responsive to provision of the user interface element configured to extend the computing session to at least the second timestamp. The one or more processors can terminate the computing session responsive to expiration of the counter without detection of an interaction with the user interface element. The one or more processors can automatically extend the computing session to at least the second timestamp responsive to the difference less than the threshold. The event can include a communication channel between the computing session and a second computing session remote from the one or more processors.

An aspect of this disclosure can be directed to a method. The method can include detecting, by one or more processors, coupled to memory, a condition to terminate, at a first timestamp, a computing session established by the one or more processors. The method can include identifying, by the one or more processors, responsive to detection of the condition and prior to termination of the computing session, an event for execution in the computing session at a second timestamp subsequent to the first timestamp. The method can include providing, by the one or more processors, based on a difference between the second timestamp and the first timestamp less than or equal to a threshold, a user interface element configured to extend the computing session to at least the second timestamp.

The method can include invoking, by the one or more processors responsive to detection of the condition and prior to termination of the computing session, a script configured to access a data structure that maintains a plurality of events to be executed in the computing session at a plurality of timestamps. The method can include determining, by the one or more processors based on a keyword of the event, that the computing session executes the event.

The method can include detecting, by the one or more processors, the condition based on a duration of inactivity in the computing session being greater than or equal to a timeout value. The method can include receiving, via the user interface element, an instruction to extend the computing session to the at least the second timestamp. The method can include preventing, responsive to the instruction, termination of the computing session to at least the second timestamp to reduce an occurrence of an authentication process to re-establish the computing session to execute the event.

An aspect of this disclosure can be directed to a non-transitory computer-readable medium. The non-transitory computer-readable medium can store instructions that, when executed by one or more processors, cause the one or more processors to detect a condition to terminate, at a first timestamp, a computing session established by the one or more processors. The instructions can include instructions to identify, responsive to detection of the condition and prior to termination of the computing session, an event for execution in the computing session at a second timestamp subsequent to the first timestamp. The instructions can include instructions to provide, based on a difference between the second timestamp and the first timestamp less than or equal to a threshold, a user interface element configured to extend the computing session to at least the second timestamp.

The instructions can further include instructions to invoke, responsive to detection of the condition and prior to termination of the computing session, a script configured to access a data structure that maintains a plurality of events to be executed in the computing session at a plurality of timestamps.

These and other aspects and implementations are discussed in detail below. The foregoing information and the following detailed description include illustrative examples of various aspects and implementations, and provide an overview or framework for understanding the nature and character of the claimed aspects and implementations. This Summary is not intended to identify key features or essential features, nor is it intended to limit the scope of the claims included herewith. The drawings provide illustration and a further understanding of the various aspects and implementations, and are incorporated in and constitute a part of this specification. Aspects can be combined and it will be readily appreciated that features described in the context of one aspect of the invention can be combined with other aspects. Aspects can be implemented in any convenient form. For example, by appropriate computer programs, which may be carried on appropriate carrier media (computer readable media), which may be tangible carrier media (e.g. disks) or intangible carrier media (e.g. communications signals). Aspects may also be implemented using suitable apparatus, which may take the form of programmable computers running computer programs arranged to implement the aspect. As used in the specification and in the claims, the singular form of ‘a’, ‘an’, and ‘the’ include plural referents unless the context clearly dictates otherwise.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of embodiments of a computing device;

FIG. 1B is a block diagram depicting a computing environment comprising client device in communication with cloud service providers;

FIG. 2A is a block diagram of an example system in which resource management services may manage and streamline access by clients to resource feeds (via one or more gateway services) and/or software-as-a-service (SaaS) applications;

FIG. 2B is a block diagram showing an example implementation of the system shown in FIG. 2A in which various resource management services as well as a gateway service are located within a cloud computing environment;

FIG. 2C is a block diagram similar to that shown in FIG. 2B but in which the available resources are represented by a single box labeled “systems of record,” and further in which several different services are included among the resource management services;

FIG. 3 is a block diagram of an example system for inactivity logoff adjustment based on scheduled events, in accordance with one or more implementations;

FIG. 4 is an example block diagram for monitoring activities and events of the user, in accordance with one or more implementations;

FIG. 5 is an example illustration of a user interface element, in accordance with one or more implementations;

FIG. 6 is an example flow diagram of a method for inactivity logoff adjustment based on scheduled events, in accordance with one or more implementations; and

FIG. 7 is an example flow diagram of a method for providing a user interface element, in accordance with one or more implementations.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:
Section A describes a computing environment which may be useful for practicing embodiments described herein;
Section B describes resource management services for managing and streamlining access by clients to resource feeds; and
Section C describes systems and methods for inactivity logoff adjustment based on scheduled events.

### A. Computing Environment

Prior to discussing the specifics of embodiments of the systems and methods of an appliance and/or client, it may be helpful to discuss the computing environments in which such embodiments may be deployed.

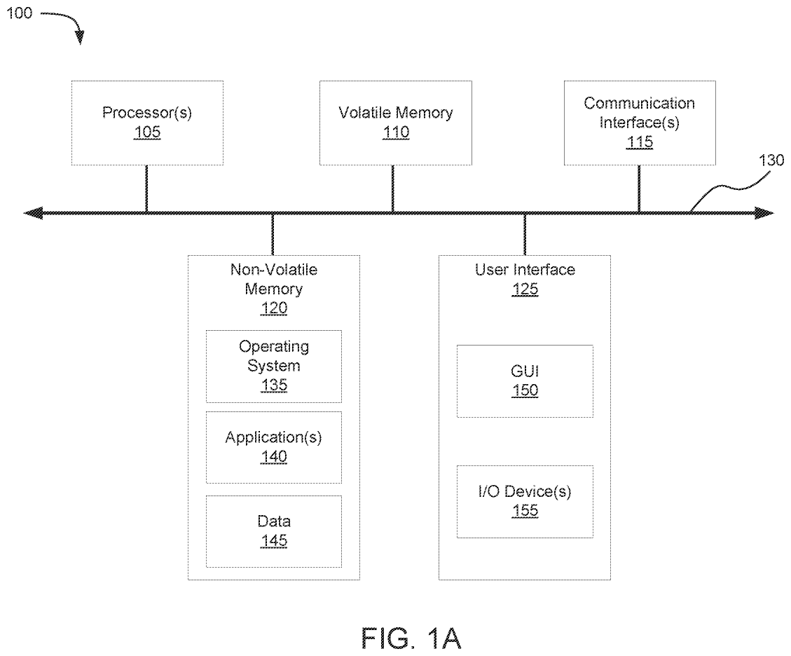

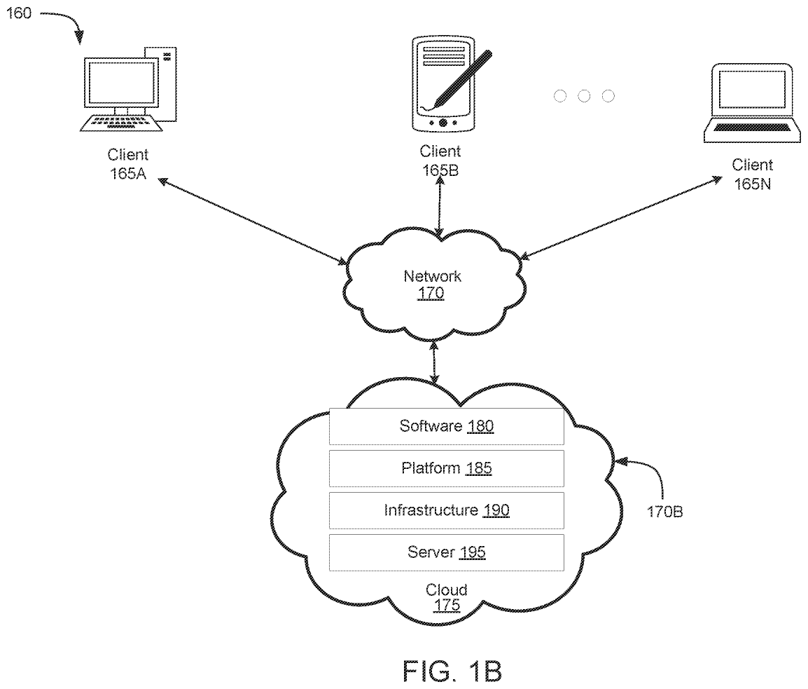

As shown in FIG. 1A, computer 100 may include one or more processors 105, volatile memory 110 (e.g., random access memory (RAM)), non-volatile memory 120 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 125, one or more communications interfaces 115, and communication bus 130. User interface 125 may include graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). Non-volatile memory 120 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than a main memory. Data may be entered using an input device of GUI 150 or received from I/O device(s) 155. Various elements of computer 100 may communicate via one or more communication buses, shown as communication bus 130.

Computer 100 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 115 may include one or more interfaces to enable computer 100 to access a computer network such as a Local Area Network (LAN), a Wide Area Network (WAN), a Personal Area Network (PAN), or the Internet through a variety of wired and/or wireless or cellular connections.

In described embodiments, the computing device 100 may execute an application on behalf of a user of a client computing device. For example, the computing device 100 may execute a virtual machine, which provides an execution session within which applications execute on behalf of a user or a client computing device, such as a hosted desktop session. The computing device 100 may also execute a terminal services session to provide a hosted desktop environment. The computing device 100 may provide access to a computing environment including one or more of one or more applications, one or more desktop applications, and one or more desktop sessions in which one or more applications may execute.

Referring to FIG. 1B, a computing environment 160 is depicted. Computing environment 160 may generally be implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing, or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but are not limited to, networks, network bandwidth, servers, processing, memory, storage, applications, virtual machines, databases, software, hardware, analytics, and intelligence.

In some embodiments, the computing environment 160 may provide client 165 with one or more resources provided by a network environment. The computing environment 160 may include one or more clients 165a-165n, in communication with a cloud 175 over one or more networks 170. Clients 165 may include, e.g., thick clients, thin clients, and zero clients. The cloud 108 may include back-end platforms, e.g., servers, storage, server farms or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In some embodiments, the computing environment 160 can include a hybrid cloud that is a combination of a public cloud and a private cloud. For example, the cloud 175 may be public, private, or hybrid. Public clouds 108 may include public servers that are maintained by third parties to the clients 165 or the owners of the clients 165. The servers may be located off-site in remote geographical locations as disclosed above or otherwise. Public clouds 175 may be connected to the servers over a public network 170. Private clouds 175 may include private servers that are physically maintained by clients 165 or owners of clients 165. Private clouds 175 may be connected to the servers over a private network 170. Hybrid clouds 175 may include both the private and public networks 170 and servers.

The cloud 175 may include back-end platforms, e.g., servers, storage, server farms or data centers. For example, the cloud 175 can include or correspond to a server or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control, and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g., Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers, or virtualization resources from large pools, allowing the users to quickly scale up by accessing more resources as needed. Examples of IaaS include AMAZON WEB SERVICES provided by Amazon.com, Inc., of Seattle, Washington; RACKSPACE CLOUD provided by Rackspace US, Inc., of San Antonio, Texas; Google Compute Engine provided by Google Inc. of Mountain View, California; or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington; Google App Engine provided by Google Inc.; and HEROKU provided by Heroku, Inc., of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc.; SALESFORCE provided by Salesforce.com Inc. of San Francisco, California; or OFFICE 365 provided by Microsoft Corporation. Examples of SaaS may also include data storage providers, e.g., DROPBOX provided by Dropbox, Inc., of San Francisco, California; Microsoft SKYDRIVE provided by Microsoft Corporation; Google Drive provided by Google Inc.; or Apple ICLOUD provided by Apple Inc. of Cupertino, California.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g., GOOGLE CHROME, Microsoft INTERNET EXPLORER, or Mozilla Firefox provided by Mozilla Foundation of Mountain View, California). Clients 165 may also access SaaS resources through smartphone or tablet applications, including, e.g., Salesforce Sales Cloud or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Resource Management Services for Managing and Streamlining Access by Clients to Resource Feeds

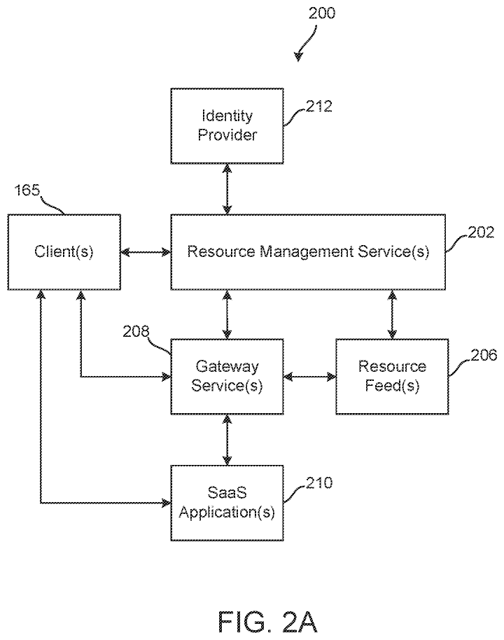

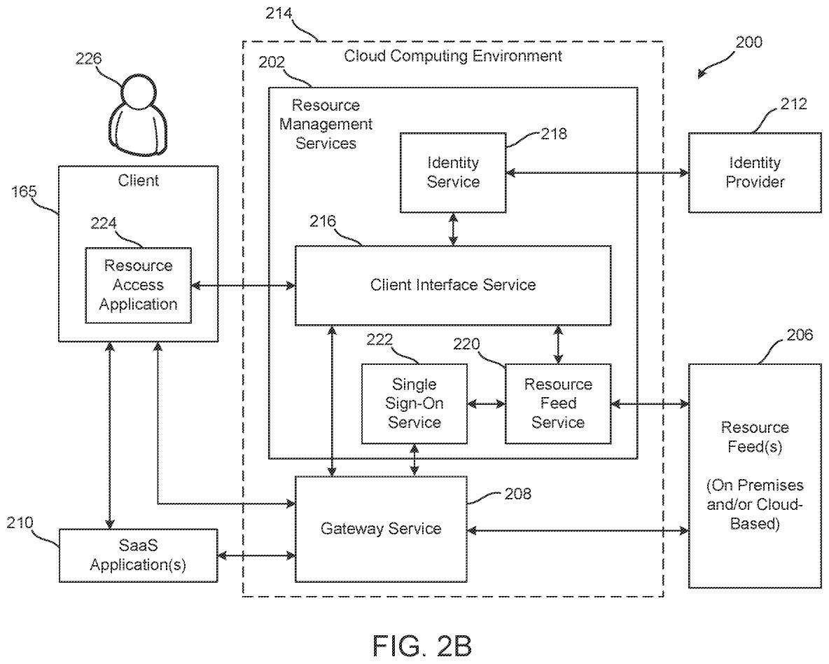

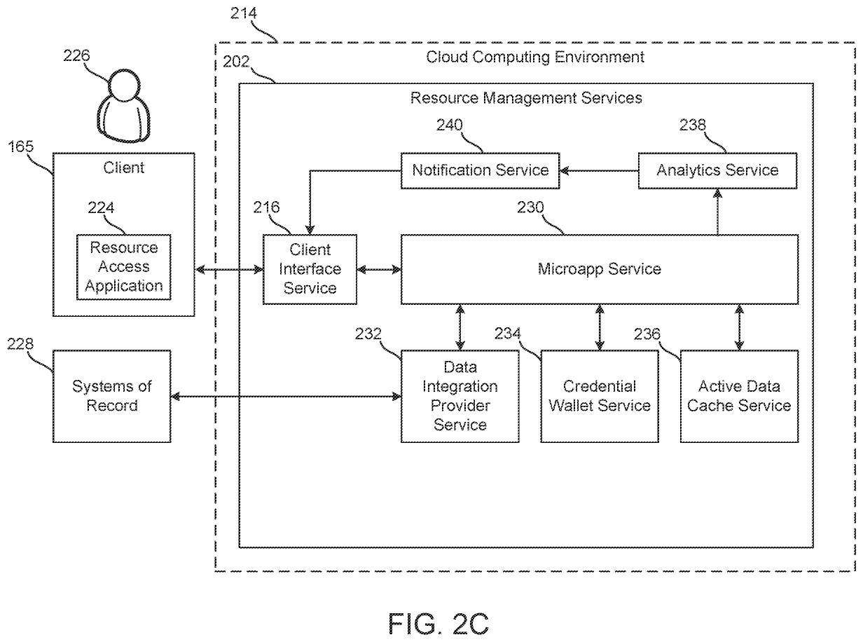

FIG. 2A is a block diagram of an example system 200 in which one or more resource management services 202 may manage and streamline access by one or more clients 165 to one or more resource feeds 206 (via one or more gateway services 208) and/or one or more software-as-a-service (SaaS) applications 210. In particular, the resource management service(s) 202 may employ an identity provider 212 to authenticate the identity of a user of a client 165 and, following authentication, identify one of more resources the user is authorized to access. In response to the user selecting one of the identified resources, the resource management service(s) 202 may send appropriate access credentials to the requesting client 165, and the client 165 may then use those credentials to access the selected resource. For the resource feed(s) 206, the client 165 may use the supplied credentials to access the selected resource via a gateway service 208. For the SaaS application(s) 210, the client 165 may use the credentials to access the selected application directly.

The client(s) 165 may be any type of computing devices capable of accessing the resource feed(s) 206 and/or the SaaS application(s) 210, and may, for example, include a variety of desktop or laptop computers, smartphones, tablets, etc. The resource feed(s) 206 may include any of numerous resource types and may be provided from any of numerous locations. In some embodiments, for example, the resource feed(s) 206 may include one or more systems or services for providing virtual applications and/or desktops to the client(s) 165, one or more file repositories and/or file sharing systems, one or more secure browser services, one or more access control services for the SaaS applications 210, one or more management services for local applications on the client(s) 165, one or more internet enabled devices or sensors, etc. Each of the resource management service(s) 202, the resource feed(s) 206, the gateway service(s) 208, the SaaS application(s) 210, and the identity provider 212 may be located within an on-premises data center of an organization for which the system 200 is deployed, within one or more cloud computing environments, or elsewhere.

FIG. 2B is a block diagram showing an example implementation of the system 200 shown in FIG. 2A in which various resource management services 202 as well as a gateway service 208 are located within a cloud computing environment 214. The cloud computing environment may, for example, include Microsoft Azure Cloud, Amazon Web Services, Google Cloud, or IBM Cloud.

For any of the illustrated components (other than the client 165) that are not based within the cloud computing environment 214, cloud connectors (not shown in FIG. 2B) may be used to interface those components with the cloud computing environment 214. Such cloud connectors may, for example, run on Windows Server instances hosted in resource locations and may create a reverse proxy to route traffic between the site(s) and the cloud computing environment 214. In the illustrated example, the cloud-based resource management services 202 include a client interface service 216, an identity service 218, a resource feed service 220, and a single sign-on service 222. As shown, in some embodiments, the client 165 may use a resource access application 224 to communicate with the client interface service 216 as well as to present a user interface on the client 165 that a user 226 can operate to access the resource feed(s) 206 and/or the SaaS application(s) 210. The resource access application 224 may either be installed on the client 165, or may be executed by the client interface service 216 (or elsewhere in the system 200) and accessed using a web browser (not shown in FIG. 2B) on the client 165.

As explained in more detail below, in some embodiments, the resource access application 224 and associated components may provide the user 226 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 224 is launched or otherwise accessed by the user 226, the client interface service 216 may send a sign-on request to the identity service 218. In some embodiments, the identity provider 212 may be located on the premises of the organization for which the system 200 is deployed. The identity provider 212 may, for example, correspond to an on-premises Windows Active Directory. In such embodiments, the identity provider 212 may be connected to the cloud-based identity service 218 using a cloud connector (not shown in FIG. 2B), as described above. Upon receiving a sign-on request, the identity service 218 may cause the resource access application 224 (via the client interface service 216) to prompt the user 226 for the user's authentication credentials (e.g., user-name and password). Upon receiving the user's authentication credentials, the client interface service 216 may pass the credentials along to the identity service 218, and the identity service 218 may, in turn, forward them to the identity provider 212 for authentication, for example, by comparing them against an Active Directory domain. Once the identity service 218 receives confirmation from the identity provider 212 that the user's identity has been properly authenticated, the client interface service 216 may send a request to the resource feed service 220 for a list of subscribed resources for the user 226.

In other embodiments (not illustrated in FIG. 2B), the identity provider 212 may be a cloud-based identity service, such as a Microsoft Azure Active Directory. In such embodiments, upon receiving a sign-on request from the client interface service 216, the identity service 218 may, via the client interface service 216, cause the client 165 to be redirected to the cloud-based identity service to complete an authentication process. The cloud-based identity service may then cause the client 165 to prompt the user 226 to enter the user's authentication credentials. Upon determining the user's identity has been properly authenticated, the cloud-based identity service may send a message to the resource access application 224 indicating the authentication attempt was successful, and the resource access application 224 may then inform the client interface service 216 of the successfully authentication. Once the identity service 218 receives confirmation from the client interface service 216 that the user's identity has been properly authenticated, the client interface service 216 may send a request to the resource feed service 220 for a list of subscribed resources for the user 226.

For each configured resource feed, the resource feed service 220 may request an identity token from the single sign-on service 222. The resource feed service 220 may then pass the feed-specific identity tokens it receives to the points of authentication for the respective resource feeds 206. Each resource feed 206 may then respond with a list of resources configured for the respective identity. The resource feed service 220 may then aggregate all items from the different feeds and forward them to the client interface service 216, which may cause the resource access application 224 to present a list of available resources on a user interface of the client 165. The list of available resources may, for example, be presented on the user interface of the client 165 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®), one or more secure browsers, one or more interne enabled devices or sensors, one or more local applications installed on the client 165, and/or one or more SaaS applications 210 to which the user 226 has subscribed. The lists of local applications and the SaaS applications 210 may, for example, be supplied by resource feeds 206 for respective services that manage which such applications are to be made available to the user 226 via the resource access application 224. Examples of SaaS applications 210 that may be managed and accessed as described herein include Microsoft Office 365 applications, SAP SaaS applications, Workday applications, etc.

For resources other than local applications and the SaaS application(s) 210, upon the user 226 selecting one of the listed available resources, the resource access application 224 may cause the client interface service 216 to forward a request for the specified resource to the resource feed service 220. In response to receiving such a request, the resource feed service 220 may request an identity token for the corresponding feed from the single sign-on service 222. The resource feed service 220 may then pass the identity token received from the single sign-on service 222 to the client interface service 216 where a launch ticket for the resource may be generated and sent to the resource access application 224. Upon receiving the launch ticket, the resource access application 224 may initiate a secure session to the gateway service 208 and present the launch ticket. When the gateway service 208 is presented with the launch ticket, it may initiate a secure session to the appropriate resource feed and present the identity token to that feed to seamlessly authenticate the user 226. Once the session initializes, the client 165 may proceed to access the selected resource.

When the user 226 selects a local application, the resource access application 224 may cause the selected local application to launch on the client 165. When the user 226 selects a SaaS application 210, the resource access application 224 may cause the client interface service 216 request a one-time uniform resource locator (URL) from the gateway service 208 as well as a preferred browser for use in accessing the SaaS application 210. After the gateway service 208 returns the one-time URL and identifies the preferred browser, the client interface service 216 may pass that information along to the resource access application 224. The client 165 may then launch the identified browser and initiate a connection to the gateway service 208. The gateway service 208 may then request an assertion from the single sign-on service 222. Upon receiving the assertion, the gateway service 208 may cause the identified browser on the client 165 to be redirected to the logon page for identified SaaS application 210 and present the assertion. The SaaS may then contact the gateway service 208 to validate the assertion and authenticate the user 226. Once the user has been authenticated, communication may occur directly between the identified browser and the selected SaaS application 210, thus allowing the user 226 to use the client 165 to access the selected SaaS application 210.

In some embodiments, the preferred browser identified by the gateway service 208 may be a specialized browser embedded in the resource access application 224 (when the resource application is installed on the client 165) or provided by one of the resource feeds 206 (when the resource application 224 is located remotely), e.g., via a secure browser service. In such embodiments, the SaaS applications 210 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (4) restricting navigation, e.g., by disabling the next and/or back browser buttons, (5) restricting downloads, e.g., by disabling the ability to download from within the SaaS application, and (6) displaying watermarks, e.g., by overlaying a screen-based watermark showing the username and IP address associated with the client 165 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 206) for assessment of its security risk by a web filtering service. For approved URLs, the specialized browser may be permitted to access the link. For suspicious links, however, the web filtering service may have the client interface service 216 send the link to a secure browser service, which may start a new virtual browser session with the client 165, and thus allow the user to access the potentially harmful linked content in a safe environment.

In some embodiments, in addition to or in lieu of providing the user 226 with a list of resources that are available to be accessed individually, as described above, the user 226 may instead be permitted to choose to access a streamlined feed of event notifications and/or available actions that may be taken with respect to events that are automatically detected with respect to one or more of the resources. This streamlined resource activity feed, which may be customized for each user 226, may allow users to monitor important activity involving all of their resources—SaaS applications, web applications, Windows applications, Linux applications, desktops, file repositories and/or file sharing systems, and other data through a single interface—without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 165 to notify a user 226 of something that requires the user's attention (e.g., approval of an expense report, new course available for registration, etc.).

FIG. 2C is a block diagram similar to that shown in FIG. 2B but in which the available resources (e.g., SaaS applications, web applications, Windows applications, Linux applications, desktops, file repositories and/or file sharing systems, and other data) are represented by a single box 228 labeled “systems of record,” and further in which several different services are included within the resource management services block 202. As explained below, the services shown in FIG. 2C may enable the provision of a streamlined resource activity feed and/or notification process for a client 165. In the example shown, in addition to the client interface service 216 discussed above, the illustrated services include a microapp service 230, a data integration provider service 232, a credential wallet service 234, an active data cache service 236, an analytics service 238, and a notification service 240. In various embodiments, the services shown in FIG. 2C may be employed either in addition to or instead of the different services shown in FIG. 2B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 224 without having to launch the native application. The system shown in FIG. 2C may, for example, aggregate relevant notifications, tasks, and insights, and thereby give the user 226 a dynamic productivity tool. In some embodiments, the resource activity feed may be intelligently populated by utilizing machine learning and artificial intelligence (AI) algorithms. Further, in some implementations, microapps may be configured within the cloud computing environment 214, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 2C, the systems of record 228 may represent the applications and/or other resources the resource management services 202 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 202, and in particular the data integration provider service 232, may, for example, support REST API, JSON, OData-JSON, and 6ML. As explained in more detail below, the data integration provider service 232 may also write back to the systems of record, for example, using OAuth2 or a service account.

In some embodiments, the microapp service 230 may be a single-tenant service responsible for creating the microapps. The microapp service 230 may send raw events, pulled from the systems of record 228, to the analytics service 238 for processing. The microapp service may, for example, periodically pull active data from the systems of record 228.

In some embodiments, the active data cache service 236 may be single-tenant and may store all configuration information and microapp data. It may, for example, utilize a per-tenant database encryption key and per-tenant database credentials.

In some embodiments, the credential wallet service 234 may store encrypted service credentials for the systems of record 228 and user OAuth2 tokens.

In some embodiments, the data integration provider service 232 may interact with the systems of record 228 to decrypt end-user credentials and write back actions to the systems of record 228 under the identity of the end-user. The write-back actions may, for example, utilize a user's actual account to ensure all actions performed are compliant with data policies of the application or other resource being interacted with.

In some embodiments, the analytics service 238 may process the raw events received from the microapps service 230 to create targeted scored notifications and send such notifications to the notification service 240.

Finally, in some embodiments, the notification service 240 may process any notifications it receives from the analytics service 238. In some implementations, the notification service 240 may store the notifications in a database to be later served in a notification feed. In other embodiments, the notification service 240 may additionally or alternatively send the notifications out immediately to the client 165 as a push notification to the user 226.

In some embodiments, a process for synchronizing with the systems of record 228 and generating notifications may operate as follows. The microapp service 230 may retrieve encrypted service account credentials for the systems of record 228 from the credential wallet service 234 and request a sync with the data integration provider service 232. The data integration provider service 232 may then decrypt the service account credentials and use those credentials to retrieve data from the systems of record 228. The data integration provider service 232 may then stream the retrieved data to the microapp service 230. The microapp service 230 may store the received systems of record data in the active data cache service 236 and also send raw events to the analytics service 238. The analytics service 238 may create targeted scored notifications and send such notifications to the notification service 240. The notification service 240 may store the notifications in a database to be later served in a notification feed and/or may send the notifications out immediately to the client 165 as a push notification to the user 226.

In some embodiments, a process for processing a user-initiated action via a microapp may operate as follows. The client 165 may receive data from the microapp service 230 (via the client interface service 216) to render information corresponding to the microapp. The microapp service 230 may receive data from the active data cache service 236 to support that rendering. The user 226 may invoke an action from the microapp, causing the resource access application 224 to send that action to the microapp service 230 (via the client interface service 216). The microapp service 230 may then retrieve from the credential wallet service 234 an encrypted OAuth2 token for the system of record for which the action is to be invoked, and may send the action to the data integration provider service 232 together with the encrypted OAuth2 token. The data integration provider service 232 may then decrypt the OAuth2 token and write the action to the appropriate system of record under the identity of the user 226. The data integration provider service 232 may then read back changed data from the written-to system of record and send that changed data to the microapp service 230. The microapp service 230 may then update the active data cache service 236 with the updated data and cause a message to be sent to the resource access application 224 (via the client interface service 216) notifying the user 226 that the action was successfully completed.

In some embodiments, in addition to or in lieu of the functionality described above, the resource management services 202 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 202 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 202 may, for example, parse these requests and respond because they are integrated with multiple systems on the back end. In some embodiments, users may be able to interact with the virtual assistance through either the resource access application 224 or directly from another resource, such as Microsoft Teams. This feature may allow employees to work efficiently, stay organized, and delivered the specific information they are looking for.

### C. Systems and Methods for Inactivity Logoff Adjustment Based on Scheduled Events

One or more servers can host respective sessions for client devices. Individual client devices can access resources from the server via an established session. The server can configure a predefined timeout value (e.g., timeout duration or period) for individual sessions according to a policy or rule configured by an administrator. The server can initiate a timer for individual sessions subsequent to establishing the sessions with client devices. The value of the timer can indicate an inactivity duration of the user. The server can reset the timer responsive to receiving an input signal from the client device. If the timer value reaches the timeout value, the server can terminate or disconnect the user from the session. The client device can reconnect to the session or request a new session via one or more verification or authentication processes. However, certain users may have at least one scheduled event, within a relatively short timeframe following the session termination time, to which the user is likely to access resources from the server. Under such circumstances, it may be undesirable to terminate the session based only on the timeout value, thereby resulting in an increase in network traffic, resource consumption, and latency to access resources.

The systems and methods of this technical solution can monitor user activities within the established session and determine whether to terminate the session or log off the user after the user is inactive for a predetermined duration based on an upcoming event. For example, the system can collect event information associated with the user, such as calendar events, supported task lists (e.g., including a timer or a scheduled time), among other types of events. The system can detect an inactivity condition and prepare to log off the user or terminate the session. The inactivity condition may include a time duration (e.g., 5 minutes, 10 minutes, or 15 minutes) before a timer value reaches a timeout value.

After detecting the condition, the system can determine whether at least one event satisfies one or more criteria (e.g., information associated with the event and the start time of the event) indicating that the user is likely to request access to resources during the event. For example, the system can predict or determine that terminating the session would be erroneous or lead to excessive or wasted computing resource utilization. For instance, the system can perform the determination on the event(s) that occur within a predetermined duration (e.g., 15 minutes or 30 minutes) from a timeout period. If the event satisfies the one or more criteria, the system can provide a user interface element to the client device requesting confirmation to extend the session. When confirmed, the system can extend the session or skip at least one log off operation (e.g., adjust or reset the timer value). Otherwise, the device can automatically terminate the session at the timeout period. Therefore, by accounting for upcoming events instead of logging off the user according to a predefined timeout value, the device can minimize the reauthentication processes or login attempts, thereby reducing resource consumption, reducing network traffic, minimizing latency to access the resources, and enhancing user experience by avoiding unnecessary logoff and increasing productivity.

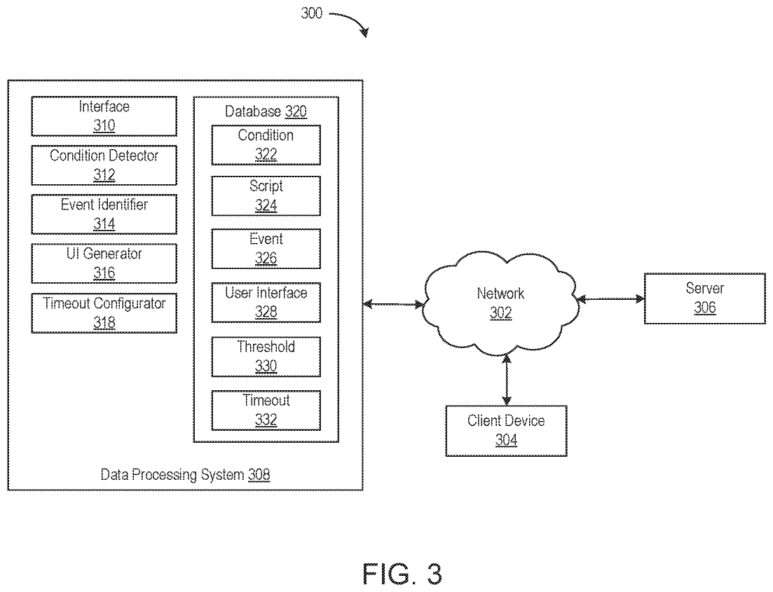

Referring to FIG. 3, depicted is a block diagram of one embodiment of a system 300 for inactivity logoff adjustment based on scheduled events. The system 300 can include at least one network 302, at least one client device 304, at least one server 306, and at least one data processing system 308. The components (e.g., network 302, client device 304, server 306, or data processing system 308) of the system 300 can include or be composed of hardware, software, or a combination of hardware and software components. The one or more components (e.g., client device 304, server 306, or data processing system 308) of the system 300 can establish communication channels or transfer data via the network 302. For example, the client device 304 can communicate with at least one of the data processing system 308 or the server 306 via the network 302. In another example, the data processing system 308 can communicate with other devices, such as the client device 304 or the server 306 via the network 302. The communication channel between various different network devices can communicate with each other via the network 302 or different networks 302.

The network 302 can include computer networks such as the Internet, local, wide, metro or other area networks, intranets, satellite networks, other computer networks such as voice or data mobile phone communication networks, and combinations thereof. The network 302 may be any form of computer network that can relay information between the one or more components of the system 300. The network 302 can relay information between client devices 304 and one or more information sources, such as web servers or external databases, amongst others. In some implementations, the network 302 may include the Internet and/or other types of data networks, such as a local area network (LAN), a wide area network (WAN), a cellular network, a satellite network, or other types of data networks. The network 302 may also include any number of computing devices (e.g., computers, servers, routers, network switches, etc.) that are configured to receive and/or transmit data within the network 302. The network 302 may further include any number of hardwired and/or wireless connections. Any or all of the computing devices described herein (e.g., client device 304, server 306, or data processing system 308) may communicate wirelessly (e.g., via WiFi, cellular, radio, etc.) with a transceiver that is hardwired (e.g., via a fiber optic cable, a CAT5 cable, etc.) to other computing devices in the network 302. Any or all of the computing devices described herein (e.g., client device 304, server 306, or data processing system 308) may also communicate wirelessly with the computing devices of the network 302 via a proxy device (e.g., a router, network switch, or gateway). In some implementations, the network 302 can be similar to or can include the network 170 or a computer network accessible to the computer 100 described herein above in conjunction with FIGS. 1A or 1B.

The system 300 can include or interface with at least one client device 304 (or various client devices 304). Client device 304 can include at least one processor and a memory, e.g., a processing circuit. The client device 304 can include various hardware or software components, or a combination of both hardware and software components. The client devices 304 can be constructed with hardware or software components and can include features and functionalities similar to the client devices 165 described hereinabove in conjunction with FIGS. 1A-B. For example, the client devices 304 can include, but is not limited to, a television device, a mobile device, smart phone, personal computer, a laptop, a gaming device, a kiosk, or any other type of computing device.

The client device 304 can include at least one interface for establishing a connection to the network 302. The client device 304 can communicate with other components of the system 300 via the network 302, such as the server 306 or the data processing system 308. For example, the client device 304 can communicate data packets with at least one server 306 via the network 302. The client device 304 can communicate with the data processing system 308 via the network 302. The client device 304 can transmit data packets to the data processing system 308 configured to select and forward the data packets from the client device 304 to at least one server 306. In some cases, the client device 304 can communicate with other client devices 304 communicatively coupled to the network 302.

The client device 304 can include, store, execute, or maintain various application programming interfaces (“APIs”) in the memory (e.g., local to the client device 304). The APIs can include or be any types of API, such as Web APIs (e.g., open APIs, Partner APIs, Internal APIs, or composite APIs), web server APIs (e.g., Simple Object Access Protocol (“SOAP”), XML-RPC (“Remote Procedure Call”), JSON-RPC, Representational State Transfer (“REST”)), among other types of APIs or protocol described hereinabove in conjunction with clients 165 of FIGS. 1B. The client device 304 can use at least one of various protocols for transmitting data to the server 306. The protocol can include at least a transmission control protocol (“TCP”), a user datagram protocol (“UDP”), or an internet control message protocol (“ICMP”). The data can include a message, a content, a request, or otherwise information to be transmitted from the client device 304 to a server 306. The client device 304 can establish a communication channel or a communication session with a server 306 and transmit data to the server 306. The client device 304 can establish a communication session or channel with the server 306 via the network 302 or other intermediary devices. In some cases, the client device 304 can transmit data to the server 306 to be forwarded or relayed to the data processing system 308. In some other cases, the client device 304 can transmit data directly to the data processing system 308. In some cases, data transmitted from the client device 304 to the server 306 can be intercepted by the data processing system 308.

The client device 304 can access resources one or more virtual applications or remote desktops by establishing a session with the server 306. For example, the client device 304 can transmit a request to establish a session to the server 306. The client device 304 can receive an authentication request from the server 306 prompting the user to provide credentials. If the user is authorized (e.g., provided valid credentials stored in the database of the server 306), the client device 304 can establish the session with the server 306. The client device 304 can access resources associated with at least one virtual application or desktop within the session.

Upon establishing the session, the client device 304 can receive a session identifier (ID) (e.g., session ticket or session key) used to connect or re-connect the client device 304 to the established session. The client device 304 can be disconnected or logged off from the session after a predefined time duration (e.g., 30 minutes, 45 minutes, or 1 hour) of session inactivity (e.g., no input has been received from the client device 304). This predefined time duration can be referred to as a timeout duration or timeout period, among other interchangeable terms. The timeout duration can be configured by the administrator of the server 306 for one or more hosted sessions. For example, the client device 304 may not receive an indication of input from the user for a certain time duration (e.g., 15 minutes). The client device 304 may receive a prompt notifying the user that the session will be disconnected after a remaining time period (e.g., another 15 minutes or 5 minutes until disconnection). If no input has been received by the server 306 after the predefined timeout duration, certain systems can disconnect the client device 304 from the session. Otherwise, if an input is received, the server 306 can extend the session or reset a timer indicative of session inactivity (e.g., user inactivity). However, users may have upcoming events within a timeframe (e.g., 5 minutes, 10 minutes, or 15 minutes) after the timeout duration. In these scenarios, it may be undesirable to log off or terminate the session solely based on the predefined timeout duration without forecasting or considering subsequent user activity on the session. Hence, computing resources may be wasted and network traffic may be increased due to unnecessarily invoking session logoff, termination, or disconnection events.

In some cases, when the client device 304 is disconnected from an established session, the session can be in a disconnected state until the client device 304 reestablish a connection with the session. The client device 304 can reconnect to the session using the existing session ID provided by the server 306, among other authentication information (e.g., username, password, multi-factor authentication (MFA)). After a predetermined duration from the disconnection time, the server 306 can terminate the session, thereby invalidating or removing the existing session ID from memory (e.g., data storage including a table of session ID associated with user information). In some cases, the server 306 can terminate the session after disconnecting the client device 304. As such, the client device 304 can request a new session from the server 306 after the previous session is terminated.

The system 300 can include or interface with one or more servers 306. The server 306 may be referred to as a host system, a cloud device, a remote device, a remote entity, or a physical machine. One or more of the servers 306 can include or correspond to as a node, remote devices, remote entities, application servers, or backend server endpoints. The server 306 can be composed of hardware or software components, or a combination of both hardware or software components. The server 306 can include resources for executing one or more applications, such as SaaS applications, network applications, or other applications within a list of available resources maintained by the server 306. The server 306 can include one or more features or functionalities of at least resource management services (e.g., resource management services 202) or other components within the cloud computing environment (e.g., cloud computing environment 214), such as in conjunction with FIGS. 2A-C. The server 306 can communicate with the client device 304 via a communication channel established by the network 302, for example.

The server 306 can communicate data packets or traffic with at least the client device 304 or the data processing system 308. The server 306 can serve or handle traffic from client devices 304 or the data processing system 308. In some cases, the server 306 can receive data from the client device 304 via the data processing system 308. For instance, the data processing system 308 can receive traffic or intercept traffic from the client device 304, and the server 306 can receive the traffic from the data processing system 308.

The server 306 can host one or more virtual machines. For example, the server 306 can be a physical machine hosting various virtual machines. The server 306 can allocate or share resources (e.g., CPU or memory resources) to the virtual machines, which may or may not be evenly distributed. The server 306 can include features or functionalities similar to a cloud computing environment 214 to provide resources for applications or services for access by the client device 304. Individual machines (e.g., virtual machines) hosted by the server 306 can be associated with a session. The server 306 can host the one or more virtual machines to establish a session with individual client device 304 when receiving a request for session establishment. The server 306 can provide the client device 304 with resources via the established session. In some cases, the server 306 can include or maintain a log of historical hardware performance of the virtual machines, such as CPU utilization, RAM utilization, network bandwidth, read or write speed, etc. In some cases, the server 306 can include or maintain a log of historical activity data of the user, such as input data (e.g., keyboard input or mouse input), resource(s) accessed (e.g., executing, initiating, or terminating applications), login time, log off time, inactivity timer (e.g., a count or countdown of last activity recorded), among other indications of activity from the user. The server 306 may be managed by an administrator (e.g., an administrative entity). The server 306 may provide logged data, such as the historical hardware performance data or historical activity data to to other entities or devices, such as the data processing system 308. In some cases, the server 306 can include one or more features, functionalities, or components similar to, or perform one or more operations of the data processing system 308. The server 306 may be remote from the data processing system 308. In some cases, the server 306 can include the data processing system 308 as part of the server 306.

The server 306 can store a list (e.g., table, map, or storage) of session IDs associated with individual client devices 304. The server 306 can add a session ID to the list responsive to a session request and successful authentication information from the client device 304. The server 306 can host a virtual machine for establishing a session with the client device 304 upon successful authentication. The server 306 can disconnect or log off the user from the session due to inactivity. The inactivity duration (e.g., timeout duration or timeout period) may be configured by the administrator of the server 306. In some cases, the server 306 can terminate the session after a preconfigured duration of inactivity. For example, the server 306 can terminate the session responsive to logging off the user (e.g., a few seconds or within a minute). In another example, the server 306 can terminate the session after a second duration (e.g., 30 minutes or 1 hour) from disconnecting the user, e.g., the user has not re-establish with the existing session.

Since it may be undesirable to disconnect the user from the session or terminate the session (e.g., premature disconnection) at the pre-configured time due to one or more upcoming events (e.g., scheduled events), the server 306 can communicate with the data processing system 308 to determine whether to skip the log off operation (e.g., extend the session) or proceed with disconnecting the user. In some cases, the server 306 can include features or functionalities of one or more components of the data processing system 308 to determine whether to disconnect the user based on the preconfigured timeout duration or value. As such, the server 306 can disconnect the user or terminate the session based on and subsequent to receiving instructions from the data processing system 308.

The system 300 can include at least one data processing system 308. The data processing system 308 can include various components to manage session connection and disconnection (e.g., logoff). The data processing system 308 can include at least one interface 310, at least one condition detector 312, at least one event identifier 314, at least one user interface (UI) generator 316, at least one timeout configurator 318, and at least one database 320. The database 320 can include at least one condition storage 322, at least one script storage 324, at least one event storage 326, at least one user interface storage 328, at least one threshold storage 330, and at least one timeout storage 332. Individual components (e.g., interface 310, condition detector 312, event identifier 314, UI generator 316, or timeout configurator 318) of the data processing system 308 can be composed of hardware, software, or a combination of hardware and software components. Individual components of the data processing system 308 can be in electrical communication with each other. For instance, the interface 310 can exchange data or communicate with the condition detector 312, event identifier 314, UI generator 316, or timeout configurator 318. The one or more components of the data processing system 308 can be used to perform features or functionalities, such as detecting one or more conditions of a session, identifying at least one event, generating a UI for display on the client device 304 (or other devices of the user), or configuring the timeout period. The data processing system 308 can operate remotely from the client device 304, the server 306, or other devices in the system 300.

In some cases, the data processing system 308 can be a part of the client device 304 or the server 306, such as an integrated device, embedded device, a server-operated device, or a device accessible by the administrator of the server 306. For example, the data processing system 308 can perform operations local or on-premise to the client device 304 or the server 306. One or more components (e.g., interface 310, condition detector 312, event identifier 314, UI generator 316, or timeout configurator 318) of the data processing system 308 can be executed on the client device 304 or the server 306. The data processing system 308 can be a part of or correspond to a virtual machine of the server 306 executing an application for the client device 304. For example, the operations of the data processing system 308 can be performed by the virtual machine assigned to the respective client device 304. In some cases, one or more components or functions of the data processing system 308 can be packaged into a script, agent, or bot configured to execute on the client device 304 or server 306.

The interface 310 can interface with the network 302, devices within the system 300 (e.g., client devices 304 or servers 306), or components of the data processing system 308. The interface 310 can include features and functionalities similar to the communication interface 115 to interface with the aforementioned components, such as in conjunction with FIG. 1A. For example, the interface 310 can include standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). The interface 310 can include at least a built-in network adapter, network interface card, PCMCIA network card, EXPRESSCARD network card, card bus network adapter, wireless network adapter, USB network adapter, modem, or any other device suitable for interfacing one or more devices within the system 300 to any type of network capable of communication. The interface 310 can communicate with one or more aforementioned components to receive data from at least one of the client devices 304 or the servers 306 (e.g., live data or historical data), such as activity data of the user, event information (e.g., scheduled events) of the user, or conditions configured by the administrator of the server 306. The interface 310 can receive the activity data from the client device 304 based on input data transmitted to the data processing system 308 or the server 306. The interface 310 can receive the activity data from the server 306 which receives network traffic from the client device 304 within the established session.

The condition detector 312 can identify or obtain a timeout value associated with one or more sessions established between the client device 304 and the server 306. The timeout value can be referred to as or correspond to a timeout duration, timeout period, or a disconnection time. The timeout value can represent a time duration of inactivity until the session is disconnected or terminated, or when the user is logged off by the server 306 (or the virtual machine) hosting the session. The timeout value may be configured by the administrator of the server 306, such as 30 minutes, 45 minutes, 1 hour, etc. For example, the condition detector 312 can obtain the timeout value from the server 306 (e.g., the resource management services 202). The timeout value may be stored on the server 306 or in a remote data repository accessible by the server 306. In some cases, the condition detector 312 can obtain the timeout value stored in the database 320, which can be updated by the server 306.

For example, the condition detector 312 can receive or obtain the timeout value from the server 306 or other servers remote from the data processing system 308. The condition detector 312 can receive this timeout value upon the establishment of the computing session between the client device 304 with the one or more servers 306 via an authentication handshake process. The timeout value can be established by the administrator of the session or the server 306 that is different from a user of the client device 304 that established the computing session.

The condition detector 312 can obtain an indication of a timer (e.g., counter) associated with the session. The indication of the timer can correspond to a timer value. The condition detector 312 can obtain the timer value from the server 306 hosting the session. In some cases, the condition detector 312 can obtain the timer value from the client device 304. The timer value can represent an inactivity time of the user (e.g., inactivity duration or how long the user has been inactive from the session). The timer can be managed by the condition detector 312, the client device 304, or the server 306. For example, the condition detector 312 can initiate a timer responsive to the client device 304 establishing the session with the server 306. In another example, the condition detector 312 may initiate a timer when the client device 304 connects to the session.

The condition detector 312 can increment the timer value (e.g., every second) based on session inactivity. In some cases, the timer value may be set to the timeout value. As such, the condition detector 312 can decrement the timer value based on session inactivity. The condition detector 312 can reset the timer value (e.g., to zero for incrementation or to the timeout value for decrementation) in response to receiving an indication of user activity, such as keypress, mouse input, among other indications of the user's presence in the session. Similar operations can be performed by the client device 304 or the server 306 to manage the timer value.

The condition detector 312 can detect a condition to terminate, disconnect, or log off the session (e.g., computing session). The condition detector 312 can compare the timer value to the timeout value to determine whether the termination condition is satisfied. For example, based on the comparison, the condition detector 312 may detect the termination condition if the timer value (e.g., duration of inactivity in the session) is greater than or equal to the timeout value. Otherwise, based on the comparison, the condition detector 312 may not detect the termination condition if the timer value is less than the timeout value. The termination condition can indicate that the server 306 is about to begin or beginning to execute a disconnection process of the session, for example, within 5 minutes, 10 minutes, or 15 minutes from disconnection depending on the configuration of the server 306. The condition detector 312 can detect the termination condition at a first timestamp. As such, the first timestamp can represent a time when the session is disconnected or a time before (e.g., 5 minutes, 10 minutes, or 15 minutes) the session is disconnected.

In some cases, to detect a termination condition, the condition detector 312 can determine whether the timer has expired. For example, the condition detector 312 can decrement the timer value during inactivity time, and reset the timer value to the timeout value when the user is active in the session (e.g., received input from the client device 304). Accordingly, the condition detector 312 can detect a termination condition based on timer expiration (e.g., at the first timeframe). The first timeframe can indicate a time when the server 306 disconnects the computing session or when a predetermined time remains (e.g., 5 minutes, 10 minutes, or 15 minutes) until the disconnection. In some cases, the first timeframe can indicate a time when a user interface (e.g., prompt or notification) is generated (e.g., by the UI generator 316 or the server 306) for presentation to the user indicating a remaining time until the session is disconnected. In this case, the condition detector 312 may initiate a second timer decrementing from or incrementing to the remaining time based on session inactivity.

The event identifier 314 can identify or collect event information associated with the user. The event identifier 314 can perform the event identification process before or at the first timestamp when the termination condition is detected. Any information associated with an event, such as a timestamp or description of the event can be a part of an event parameter. The event identifier 314 can perform the event identification process prior to termination or disconnection of the computing session, such as 5 minutes, 10 minutes, or 15 minutes before the disconnection. The event information can include any indication of scheduled events, tasks, meetings, among other agenda items.

For example, the event identifier 314 can detect or determine an account identifier (ID) (e.g., user ID or client ID) associated with the computing session that triggered the termination condition. The event identifier 314 can invoke a script configured to access a data structure of the client device 304 or the server 306 that maintains the event information associated with the account identifier (e.g., events scheduled for the user). The client device 304 can maintain a locally stored data structure including the event information. The server 306 (or other servers) can maintain the data structure within a remote data repository including event information aggregated from the client device 304 or the data processing system 308 (e.g., database 320). The data structure can include events to be executed in the computing session at various timestamps or timeframes. The data structure may be referred to as or used interchangeably with other descriptive terms, such as data repository, source code, computer file, or metadata. The script can be configurable, such as by the administrator, for compatibility to access the data structure. The script can include code or computer-readable instructions used for accessing the event information, such as calendar events, scheduled events, a list of reminders, among other planners with timestamps scheduled or accepted by the user. For example, the event identifier 314 can access a data structure maintained, managed, or otherwise generated by an application that executes on the client device 304 or as a SaaS application or network application on the server 306, such as a calendar application or an electronic messaging application. As such, the event identifier 314 can use or invoke the script to identify events stored in the data structure of at least one of the client device 304 or the server 306.

In some cases, the data structure may be maintained in the database 320 of the data processing system 308. For example, the event identifier 314 can communicate or access the data structure maintained in the database 320. The data structure can include a listing, metric, or map of events scheduled for the user accessing the session. The data structure maintained in the database 320 can include similar event information as in the data structure of the client device 304 or the server 306. The event identifier 314 may receive or obtain an update to the event information from at least one of the client device 304 or the server 306. The update may include an additional event (e.g., a timeframe of the event and a description of the event) to add to the data structure. The update may include an indication to remove an existing event from the data structure. The update may include modifications to existing events, such as updated timestamps, descriptions, among other event information. For example, the event identifier 314 may receive an indication of changes (e.g., update) to the event information stored on the client device 304 (e.g., user modifying an event in the calendar or list). In another example, the event identifier 314 may receive an indication of changes (e.g., update) to the event information stored remotely on one or more servers 306. The event identifier 314 can update the data structure maintained in the database 320 (or maintained on the client device 304 or the server 306) responsive to (e.g., in real-time) receiving the update. In some cases, the event identifier 314 can update the data structure periodically, such as minutely, hourly, or daily.

In some cases, the event identifier 314 can compare the data structure stored in the database 320 to at least one other data structure stored on the client device 304 or the server 306. The data structure can include or be associated with an update timestamp. For example, if the event identifier 314 detects a difference in event information between the data structures, the event identifier 314 may update the data structure of the database 320 or the data structure maintained on the client device 304 or the server 306. The event identifier 314 can update any data structure based on at least one data structure having the most recent update timestamp (e.g., compared to update timestamps of other data structures). Additionally or alternatively, the event identifier 314 can identify events associated with the account identifier from other devices, such as a different client device of the user, a different server, or other devices connected to the network 302.

The event identifier 314 can identify or determine a timestamp (e.g., a second timestamp) of individual events. The event identifier 314 may select or filter certain events based on the timestamp of the event. For example, the event identifier 314 can identify a threshold indicative of an (e.g., maximum) allowable duration from the first timestamp (e.g., when detecting the condition or disconnecting the session) to the second timestamp (e.g., start of the event). The event identifier 314 can compare a difference between the first timestamp and the timestamp (e.g., starting time) of the event to the threshold. If the difference is at or below the threshold (e.g., satisfies the threshold), the event identifier 314 can select the event for consideration (e.g., considering the event for extending session time). If the difference is above the threshold (e.g., does not satisfy the threshold), the event identifier 314 can filter the event from consideration.

A time after the threshold duration from the first timestamp may be referred to as a time limit, for example. The event identifier 314 can compare the second timestamp (e.g., start time of the event) to the time limit. The event identifier 314 can filter event(s) with a second timestamp that is after the time limit.

In some cases, the data structure can include time slots for various events. When accessing the data structure, the event identifier 314 can filter the event(s) associated with the time slots outside the threshold duration (e.g., occurred after the time limit). The event identifier 314 can select one or more events associated with the time slot(s) inside the threshold duration (e.g., occurred at or before the time limit). Based on the determined amount of time taken to execute the event (e.g., duration from the first timestamp), the event identifier 314 may select or filter the event from consideration.

The event identifier 314 can determine whether one or more events are for execution in the computing session. The event identifier 314 can perform this determination prior to or after determining that the difference between the first timestamp and the second timestamp is less than or equal to the threshold. For example, the event identifier 314 can perform this determination on any event. In another example, the event identifier 314 can perform this determination on one or more events starting at or before the time limit.

To determine whether the event is for execution on the session, the event identifier 314 can analyze one or more parameters associated with the event, such as the header, footer, title, subject, body, scheduling field (e.g., start time or end time), among other descriptions of the event. A parameter of the event can include or indicate whether the event is a virtual event to be executed or accessed by an application that executes on the client device. For example, the parameter can include a link, hyperlink, uniform resource locator, or deeplink that, responsive to selection, establishes a network communication channel (e.g., an audio or video call via an application executing on the client device). The event identifier 314 may identify at least one keyword indicative of the execution of the event on the session, such as “video,” “meeting,” “conference,” “participation required,” or “important,” for example.

In some cases, the keyword can be associated with the location of the event. For example, the event can include a location field. The event identifier 314 can identify at least one keyword included in the location field, such as audio link, video link, telecommunication application, dial-in number, or web conference, for example. These keywords can be configured by the administrator or the user. Certain keywords may be restricted by the administrator. Accordingly, based on the keyword of the event, the event identifier 314 can determine that the computing session executes the event. The keyword can be stored on the database 320, the client device 304, or the server 306.

The event identifier 314 may include a participation field. The participation field can include a listing of user accounts, users, or participants invited to the event. For example, the participation field can include the user account. In some cases, the event identifier 314 may determine that having more than one user account participating in the event indicates that the event is for execution in the computing session. The event identifier 314 may determine that having only one user account associated with the event may or may not indicate that the event is for execution in the session, such as based on other keywords, parameters, or indication from the description of the event.

In some cases, the parameter of the event may not include a keyword (e.g., no title or description) or may include a keyword indicative of an event that is not configured to execute in the computing session, such as “reminder,” “not important,” “personal task,” or “errand,” for example. Further, the keyword may indicate the location of the event, such as a physical address, physical conference room, restaurant, a travel location, among other locations that may not require execution of the computing session to attend the event. In this case, the event identifier 314 may determine that the event is not configured for execution in the computing session. In some other cases, the event identifier 314 may determine that event(s) within the predetermined duration from the first timestamp (e.g., at or before the time limit) is for execution in the computing session.

In various cases, the event can include a communication channel between the computing session hosted by the server 306 and another computing session (e.g., a second computing session) remote from the server 306. For example, the event identifier 314 can determine that the event accessible on a first session hosted on the server 306 is connected to a second session hosted on a separate server. The second session can relay, forward, or provide data streams to the first session, such as video stream, audio feed, or other communication to facilitate the event. In this case, the event can include a link or a redirect to establish the second session via the first session. As such, the event identifier 314 may determine that the event is configured for execution on the computing session.

The event identifier 314 can determine that the event (e.g., parameter(s) of the event) satisfies at least one criterion for extending the session time (or skipping a logoff operation). For example, the event identifier 314 can determine that the session may be extended based on the difference between the second timestamp and the first timestamp less than or equal to the threshold (e.g., threshold duration). The event identifier 314 can determine that the session may be extended based on the event configured for execution on the session. The event identifier 314 can provide an indication to the UI generator 316 on whether the event satisfies the criterion for extending the session.

The UI generator 316 can generate a UI, notification, prompt, image, or graphical user interface (GUI) for the client device 304. The UI generator 316 can obtain a pre-generated UI from the database 320. The UI can include one or more images, texts, or interactive elements, for example. The one or more interactive elements can include buttons, icons, hyperlinks, sliders, keys, etc. The UI generator 316 can generate or select the UI at or around the first timestamp (e.g., 1 second, 5 seconds, or 10 seconds after detecting the termination condition).

The UI generator 316 can generate or select the UI based on whether the session may be extended (e.g., whether the parameter of at least one event satisfies the criteria). For example, the UI generator 316 can receive an indication from the event identifier 314 regarding whether the session may be extended based on the event information. If the session may be extended, the UI generator 316 can provide a UI to the client device 304. The UI generator 316 can provide the UI to one or more client devices, such as at least one of a first client device connected to the computing session, a second client device in communication with the first client device, or another client device (e.g., executing an application or a second session) associated with the same account identifier as the established session. For example, the first client device (e.g., a laptop or a desktop) can establish a session with the server 306 using an account (e.g., identified by an account identifier). The account can include information on a second client device (e.g., a mobile device) configured for receiving notifications or other information associated with the account (e.g., login activity or session run time). Upon detection of a termination condition due to inactivity of the session, the UI generator 316 may provide the UI to the second client device configured to extend the computing session established on the first client device.

The UI can be presented on the client device 304 until an expiration time (e.g., configurable by the administrator). The UI can include an interactive element (e.g., UI element) configured to extend the computing session to at least the second timestamp (e.g., the start time of the event). For example, the interactive element can be at least one button to accept, acknowledge, or confirm a time extension of the session. The interactive element may include another button to decline or deny the session extension. In this case, the session may be prolonged until the expiration time of the UI.

Otherwise, if the session may not be extended based on the event(s) not satisfying the criteria (e.g., events start after the threshold time limit), the UI generator 316 may not provide the UI to the client device 304. Accordingly, the session can be terminated at, around, or after the first timestamp. In some cases, the UI generator 316 may provide a UI indicating the disconnection of the computing session, responsive to the determination that the event(s) (if any) does not satisfy the criteria.

In the case of an extendable session, the UI generator 316 can provide the UI for presentation on the client device 304 configured to expire after a predefined time duration. The time duration can correspond to the remaining time until the session is disconnected or terminated. For example, the UI generator 316 can initiate a timer (e.g., countdown timer) configured to expire after the time duration. The user can interact with the interactive element(s) within the time duration. If the timer expires, the session can be disconnected (e.g., by the server 306).

The UI generator 316 may receive an indication of interaction with the interactive element from the client device 304 before timer expiration. For example, the UI generator 316 can receive an indication of interaction with an interactive element configured to decline session extension. The UI generator 316 can forward the indication to the timeout configurator 318, which may not extend the timeout duration. In some cases, the UI generator 316 may forward the indication to the server 306. If the user declined the extension, the server 306 can terminate the session subsequent to receiving the indication, such as immediately or after a predefined duration from the time that the indication of interaction is received.

In another example, the UI generator 316 may receive an indication of interaction with an interactive element configured to accept an extension of the session. The UI generator 316 can forward the indication to the timeout configurator 318 to extend the session, such as skip a logoff operation (e.g., reset logoff time or adjust a logoff timer), adjust the timeout value (e.g., temporarily until disconnection or an indication of user interaction in the session), among others. In some cases, the UI generator 316 can forward the indication to the server 306 to perform one or more features or functionalities similar to the timeout configurator 318, such as extending the session time or maintaining session connection until an adjusted timeout period.

In some cases, the UI generator 316 may not receive an indication of interaction until the expiration time of the UI. In this case, the session may be disconnected by the server 306 or the data processing system 308 in response to the expiration of the UI. In some other cases, the UI generator 316 may not generate or provide the UI if the parameter of the event does not satisfy the criteria. In this case, the session can be disconnected according to the predefined timeout value without (e.g., session not extended).

The UI generator 316 can provide other configurations for the user of the client device 304. For example, the UI generator 316 can generate a configurable extension time within the UI. The configurable extension time may include a predefined extension time limit configurable by the administrator. In another example, the UI generator 316 can indicate an expiration time of the UI, a next session disconnection time (e.g., if session extension is confirmed), or other information configurable by the administrator.

In some cases, the UI generator 316 may generate and provide a prompt to the client device 304 in response to the parameter of the event satisfying the criteria. For example, if the timeout configurator 318 is configured to extend the computing session automatically based on the parameter of the event satisfying the criteria (e.g., include a certain keyword(s) or within a timeframe), the UI generator 316 can provide a notification or user interface indicating to the user that the session is extended to at least a second timestamp (e.g., extended to the start time of the event). In some cases, the UI generator 316 can provide an indication that the session is extended by a predefined time duration (e.g., 5 minutes, 10 minutes, or 15 minutes).

The timeout configurator 318 can extend the computing session to a timestamp (e.g., time) after the first timestamp. The timeout configurator 318 can extend the computing session subsequent to receiving an indication that the event parameters satisfy the criteria. The timeout configurator 318 can extend the computing session in response to receiving an instruction from the client device 304 via the UI element (e.g., user accepting to extend the session by interacting with the UI). In this case, the UI element can be configured to extend the computing session to at least the second timestamp subsequent to user interaction with the UI element. The timeout configurator 318 may receive an instruction from the UI generator 316 to extend the session.

The timeout configurator 318 can extend the computing session by skipping the logoff, disconnection, or termination operation at the first timestamp when the duration of inactivity is greater than or equal to the timeout value. For example, the timeout configurator 318 can transmit an instruction to the server 306 to skip, prevent, or dismiss the disconnection operation. By preventing the disconnection operation, the occurrences of an authentication process for re-establishing the computing session to execute the event can be reduced or minimized as necessary. In some cases, the data processing system 308 can correspond to or be a part of the server 306, such that the timeout configurator 318 can manage the computing session directly (e.g., directly configure the disconnection time or termination operation). The timeout configurator 318 can start a second timer (e.g., a countdown timer) configured to initiate a second disconnection operation. The second timer can include a timer value configured by the administrator or based on the start time (e.g., second timestamp) of the event. In another example, the timeout configurator 318 can extend the computing session by adjusting the timeout value (e.g., temporarily until session disconnection or until an indication of activity in the session). The timeout value may be adjusted to at least the second timestamp (e.g., start time of at least one event) or to a different timestamp (e.g., 5 minutes, 10 minutes, or 15 minutes) predefined by the administrator.

The timeout configurator 318 can extend the computing session by resetting a timer configured to track the duration of inactivity in the session. Therefore, the timeout configurator 318 may double the session time, and the second disconnection operation may be initiated when this timer value (e.g., duration of inactivity after the reset) is greater than or equal to the timeout value. In further example, if the client device 304 is given a predefined timeframe for session extension (e.g., via the provided UI), the timeout configurator 318 may receive an indication of a duration selected by the user. Accordingly, the timeout configurator 318 can extend the computing session by the selected duration. The timeout configurator 318 can use any other procedures or processes for skipping the disconnection operation or extending the session.

In some cases, the timeout configurator 318 can receive, from the event identifier 314, an indication of an amount of time taken to execute the event (e.g., determined based on a parameter of the event). For example, the second timestamp can include or correspond to a reminder time, a notification time, a sign-up time for the event, or any other actions configured to be performed by the user before the execution of the event. As such, the timeout configurator 318 can receive, obtain, or determine a third timestamp associated with the amount of time taken from the second timestamp to execute the event. Hence, the timeout configurator 318 may extend the computing session to at least the third timestamp.

The timeout configurator 318 may not prevent the session disconnection if there is no event for execution within the predetermined threshold duration. The timeout configurator 318 may not prevent the session disconnection if the event does not include at least one predetermined keyword or satisfy at least one of the criteria for preventing the disconnection. In these cases, the session can be terminated without the provision of the UI element configured to extend the computing session.

The timeout configurator 318 may not prevent the session disconnection if the client device 304 does not provide an instruction to prevent the disconnection within a predetermined duration (e.g., duration of presenting the UI on the client device 304). For example, the timeout configurator 318 may not receive any instruction from the client device 304 via the UI element within the time limit of a counter or timer initiated by the UI generator 316 when providing the UI element. As such, the timeout configurator 318 can terminate the computing session responsive to (e.g., immediately after) the expiration of the counter without a detection of interaction with the UI element.

In some cases, the timeout configurator 318 can be configured to automatically extend the computing session to at least the second timestamp responsive to the difference between the second timestamp and the first timestamp less than the threshold (e.g., predefined allowable extension to the session time). In this case, the timeout configurator 318 may extend the session without receiving any instruction from the client device 304. In some other cases, the timeout configurator 318 may not prevent the session disconnection if an instruction is received via the UI indicating not to extend the session or to proceed with the disconnection. If the disconnection operation is not prevented, the computing session can be terminated at the timeout period.

The database 320 may be referred to as a data repository, central storage, or memory of the data processing system 308. The one or more storages (e.g., condition storage 322, script storage 324, event storage 326, UI storage 328, threshold storage 330, or timeout storage 332) can be accessed, modified, or interacted with by one or more components (e.g., interface 310, condition detector 312, event identifier 314, UI generator 316, or timeout configurator 318) of the data processing system 308. In some cases, the one or more storages of the database 320 can be accessed by one or more other authorized devices of the system 300, such as the server 306. The database 320 can include other storages to store additional data from one or more components of the data processing system 308 or data from other devices of the system 300, for example.

The condition storage 322 can store, maintain, or include one or more conditions to be detected by the one or more components of the data processing system 308, such as the condition detector 312. For example, the condition storage 322 can include a condition to terminate, disconnect, or log off a computing session based on inactivity in the computing session (e.g., the duration can be based on at least one threshold stored in the threshold storage 330). The condition storage 322 can be accessed by the condition detector 312 for configuring the condition detector 312 to detect the termination condition (e.g., disconnection operation, logoff indication, or an initiation of a session termination process). As such, the condition of the condition storage 322 can dictate, for example, the execution of operations performed by other components of the data processing system 308 based on whether the condition is detected by the condition detector 312.

The script storage 324 can store, maintain, or include at least one script, code, or program configured to access the event information. For example, the script storage 324 can be accessed by the event identifier 314. The script storage 324 can provide the script to the event identifier 314 for execution to retrieve or obtain any event information from at least the server 306 or the client device 304. The script storage 324 can receive an update to the script from the server 306 or at least one other authorized device within the network 302. Accordingly, the script storage 324 can store the script used by the event identifier 314 to identify one or more events (e.g., scheduled events).

The event storage 326 can store, maintain, or include event information. The event information can include any information associated with individual events, such as title, subject, details, start time, end time, among other event parameters. The event information may be stored on the client device 304. The event information may be stored on the server 306. The event storage 326 can be accessed by the event identifier 314 to identify events scheduled for the user. The event storage 326 can be updated by the client device 304, the server 306, or one or more components of the data processing system 308. For example, the event storage 326 can receive updated event information, new events, or an indication to remove at least one event from the event identifier 314 subsequent to accessing events stored on the client device 304 or the server 306. In some cases, the event storage 326 can be shared with or accessed by the server 306 (e.g., directly). Hence, any update to events maintained on the client device 304 or the server 306 may be reflected in or synced with the event storage 326.

The UI storage 328 can store, maintain, or include the UI generated by the UI generator 316. In some cases, the UI may be pre-generated or preconfigured by the administrator. The UI storage 328 can be accessed by at least the UI generator 316. For example, the UI storage 328 can receive or store one or more UIs generated by the UI generator 316. In another example, the UI storage 328 can provide at least one UI element to the UI generator 316. The UI element can include texts, interactive element(s), image(s), characters, or other features for presentation to the client device 304. In some cases, the UI element can include other features for presentation within the computing session accessed via the client device 304. In some cases, the UI storage 328 can be accessed by the server 306 to update, modify, or store the UI element for usage by the UI generator 316.

The threshold storage 330 can store, maintain, or include thresholds for usage by one or more components of the data processing system 308. The thresholds may be predetermined or configured by the administrator. For example, the threshold storage 330 can store an inactivity duration threshold. The inactivity duration threshold can be used by the one or more components of the data processing system 308 (e.g., condition detector 312, event identifier 314, UI generator 316, or timeout configurator 318). The inactivity duration threshold can be used by the component(s) to determine, for example, whether a termination condition is detected or the provided UI element has expired.

The threshold storage 330 can store a threshold indicative of a time limit or duration limit between the first timestamp when the termination condition is detected and a subsequent timestamp (e.g., the second timestamp or the third timestamp) when the event executes or starts. For example, the threshold storage 330 can be accessed by the event identifier 314 to determine whether at least one event qualifies for extending the computing session. The event identifier 314 can determine whether the duration between the second timestamp (e.g., start time) of the event and the first timestamp is less than or equal to the threshold. Accordingly, the threshold can be used to determine whether at least one event qualifies for session extension or prevention of disconnection operation.

The threshold stored in the threshold storage 330 can be updated by the administrator. The threshold can be configured for individual computing sessions. In some cases, the threshold can be the same throughout all the sessions hosted by the server 306. In some other cases, selected computing sessions can include a different threshold from other computing sessions based on the account identifier. For example, an account identifier can indicate the security level configured for the user. With higher security accounts, the threshold value may be lower (e.g., shorter time to provide instruction via the UI element, shorter inactivity duration, or less time gap between the first and second timestamps) than lower security accounts, and vice versa.

The timeout storage 332 can store, maintain, or include at least one timeout value. The timeout storage 332 can be accessed by the server 306. The timeout value can be configured, defined, or provided by the administrator. In some cases, the timeout storage 332 (e.g., the timeout value) can be updated upon establishment of the computing session with the one or more servers 306 via an authentication handshake process. The timeout storage 332 can be accessed by the condition detector 312 for detecting the termination condition. For example, the timeout value can be used to compare with an inactivity duration in the computing session. Based on the comparison, the condition detector 312 can determine whether the termination condition is detected (e.g., inactivity duration is greater than or equal to the timeout value to detect the termination condition).

In some cases, the timeout storage 332 can include another timeout value configured for another inactivity duration during the extended session. For example, after the timeout configurator 318 extends the computing session, the one or more components of the data processing system 308 can monitor the inactivity duration for the computing session during this extended session time. The session can timeout and another termination condition can be triggered in response to the inactivity duration being greater than or equal to the timeout value.

In certain cases, the timeout storage 332 can include yet another timeout value configured for the UI element. For example, once the UI element is provided to the client device 304 (e.g., by the UI generator 316), the one or more components of the data processing system 308 can initiate a timer and monitor for a response from the client device 304. If the timer value is greater than or equal to the timeout value, the one or more components of the data processing system 308 may determine that the UI element has timed out. The timeout storage 332 can include other timeout values for determining whether to terminate or extend the computing sessions, as discussed herein.

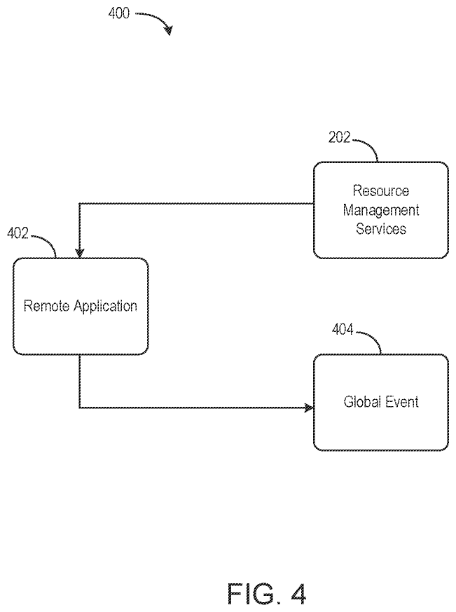

Referring to FIG. 4, depicted is an example block diagram 400 for monitoring activities and events of the user. The example diagram 400 can include one or more components to perform various operations for monitoring user activities (e.g., inactivity in a computing session), detecting a condition (e.g., termination condition) of the session, or identifying events for execution in the session. For example, the diagram 400 can include the resource management services 202, at least one remote application 404, and at least one global event 406. The example diagram 400 can include operations, which can be executed, performed, or otherwise carried out by one or more components of the system 300 (e.g., client device 304, server 306, data processing system 308, or other components of the network 302), the computer 100, the cloud computing environment 214, or any other computing devices described herein in conjunction with FIGS. 1A-3. For example, the operations can be performed by the server 306 hosting one or more computing sessions to manage the disconnection of the sessions. In another example, the operations can be performed by the data processing system 308 embedded as part of at least one server 306. In yet another example, the operations can be performed by the data processing system 308 remote from the server 306, such as an intermediary device in communication with the server 306 hosting the computing session for the user. In further example, the operations can be performed by the data processing system 308 hosting the session established by the client device 304.

The resource management services 202 can be a part of the server 306 (or the cloud computing environment 214). In some cases, the resource management services 202 can be a part of the data processing system 308. The resource management services 202 can manage resources stored on the server 306. The resource management services 202 can obtain resources from a cloud storage in communication with the server 306. For example, the resource management services 202 can access resources stored on the server 306 (or the cloud computing environment 214), such as via the resource feed 206. The resource management services 202 can obtain information or services associated with one or more applications or sessions hosted on the server 306 including at least a timeout value, a threshold associated with a maximum (e.g., limit) extension time for computing sessions, among others. The information can be configured by the administrator of the server 306.

The resource management services 202 can provide the information to one or more authorized devices within the network 302 upon request. For example, the resource management services 202 may receive a request for at least one of the timeout value or the threshold from the remote application 402. The resource management services 202 can provide at least one of the information to the remote application 402 upon request.

The global event 404 can be configured to collect events (e.g., event information) associated with individual account identifiers. The global event 404 can include, store, or maintain a collection of the events. The global event 404 (e.g., event identifier 314) can be a part of the server 306 or the data processing system 308 configured to collect or store the event information. In some cases, the global event 404 can perform features or functionalities for the server 306 or at least one component of the data processing system 308.

For example, the global event 404 can obtain, receive, or collect one or more events, tasks, or reminders scheduled for at least one user associated with an account identifier. A user of the client device 304 can export events from a local calendar installed on the client device 304, and then import those events to the global event 404 (or data processing system 308). The global event 404 can invoke or execute a script configured to access a data structure that maintains the events. The global event 404 can obtain the events from the client device 304 (e.g., local calendar), from the server 306 (e.g., listing of events or tasks stored in the cloud), or from other devices within the network 302 that are accessed using the account identifier. The global event 404 can obtain events from other applications accessed using the account identifier. For example, the global event 404 can obtain the event information from a local calendar application of the client device 304, a cloud-based calendar application from the server 306 (or other servers), a list of reminders stored on the client device 304 or the server 306, among others.

In some cases, the global event 404 can receive a request to generate at least one event from the client device 304. The global event 404 can receive a request to generate at least one event from the server 306 or the computing session of the server 306. For example, the global event 404 can communicate with an event scheduler (e.g., calendar, task list, or other scheduling application). The global event 404 can receive a request to schedule an event on the event scheduler from the client device 304. The request can include information about the event, such as an event topic, details of the event, or time (e.g., start time and end time) of the event. The global event 404 may forward the request to the event scheduler to schedule the event for the user. The global event 404 may include a data structure (e.g., database 320) that maintains the event information. The global event 404 can be accessed by the remote application 404 to identify upcoming events in the computing session, for example.

The remote application 402 can include or correspond to an application executing on the server 306, the data processing system 308, or a cloud computing device. The remote application 402 can communicate with one or more components of the data processing system 308 or the server 306. In some cases, the remote application 402 can be executed by the data processing system 308 to perform the operations of at least one component (e.g., the condition detector 312, event identifier 314, UI generator 316, or timeout configurator 318) of the data processing system 308.

The remote application 402 can be in communication with the server 306 for managing the session disconnection. In some cases, the remote application 402 can be executed on the server 306 as part of the computing session for managing session disconnection. The remote application 402 (e.g., condition detector) can monitor activities (e.g., mouse input or keyboard input) in the computing session. The remote application 402 may identify inactivities in the session. The remote application 402 can track or count the inactivity time in the session.

The remote application 402 (e.g., condition detector) can detect whether a termination condition (e.g., logoff condition or disconnection condition) is satisfied. For example, the remote application 402 can obtain or receive the timeout value from the resource management services 202. The remote application 402 can compare the inactivity duration in the session to the timeout value. The remote application 402 can determine that the condition is met (e.g., detect the termination condition) if the inactivity duration is greater than or equal to the timeout value. The remote application 402 can determine that the condition is not met if the inactivity duration is less than the timeout value.

If the condition is detected, the remote application 402 may access the data structure of the global event 404 or in communication with the global event 404. The remote application 402 can identify one or more events (e.g., if any) upcoming within the threshold (e.g., within a predetermined time period), such as 10 minutes, 15 minutes, or 30 minutes. If there is no upcoming event within the threshold period from a timestamp (e.g., first timestamp) when the condition is detected, the remote application 402 can transmit a disconnection, termination, or logoff request to the server 306. In some cases, the remote application 402 may be authorized to execute a disconnect operation of the session on behalf of the server 306 hosting the session.

If at least one upcoming event executes at a timestamp (e.g., second timestamp) within the threshold period from the first timestamp, the remote application 402 (e.g., timeout configurator 318) can postpone, hold, or delay transmission of the disconnection request. The remote application 402 may be configured to automatically postpone the disconnection request until the second timestamp or a predefined duration (e.g., 15 minutes or 30 minutes) from the first timestamp. For example, the remote application 402 (e.g., timeout configurator 318) can determine whether the parameter of the event satisfies the criteria (e.g., keywords, timestamp, or description of the event) indicating an event for execution on the computing session. If the event is for execution on the computing session, the remote application 402 may automatically postpone the disconnection request until at least the second timestamp to reduce an occurrence of an authentication process to re-establish the computing session to execute the event.

In some cases, the remote application 402 may generate or provide a UI element (e.g., a notification or prompt) to the client device 304 requesting confirmation to extend the session, postpone the disconnection, or skip the pending disconnection operation. The UI element can be presented to the user within a predetermined timeframe. This timeframe can be configured by the administrator. If the UI element expires (e.g., no response received within the timeframe), the remote application 402 may transmit the disconnection request to the server 306. The remote application 402 can transmit the disconnection request to the server 306 if the user declined to extend the session.

If a confirmation is received from the client device 304 via the UI element, the remote application 402 can extend the session accordingly. The remote application 402 can extend the session by adjusting the timeout value, adjusting the inactivity duration, comparing the inactivity duration to a second timeout value, or initiating a countdown timer. For example, the remote application 402 can send the disconnection request in response to the inactivity duration greater than or equal to the second timeout value. In another example, the remote application 402 can send the disconnection request in response to the expiration of the countdown timer.

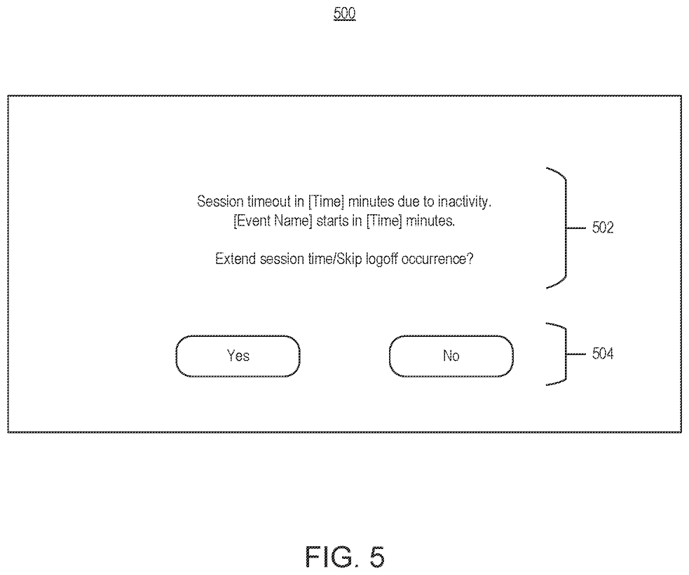

Referring to FIG. 5, depicted is an example illustration of a user interface (UI) element 500. The UI element 500 may include, correspond to, or be referred to as a notification, prompt, or message. The UI element 500 can be generated by the data processing system 308 (e.g., UI generator 316). The UI element 500 can be pre-generated and stored on the data processing system 308 (e.g., database 320) or the server 306. The UI element 500 can be provided to the client device 304 if the data processing system (e.g., event identifier 314) identifies an event that executes within a threshold duration from when the termination condition is detected.

The UI element 500 can include at least one portion 502 to provide information (e.g., detail, description, or message) for the user and one or more interactive elements 504. The portion 502 of the UI element 500 can include a remaining time until the session is disconnected. The portion 502 can include an indication of at least one event executing at a certain timestamp (e.g., second timestamp) within the threshold. The portion 502 can include an indication of a request for confirmation to extend the session.

The example interactive elements 504 can be a button, slider, checkbox, dropdown list, icon, or other elements configured for interaction by the user via the client device 304. For simplicity, the interactive elements 504 can include a “yes” (e.g., first interactive element) and a “no” (e.g., second interactive element) button. The first interactive element can be selected by the user to confirm extending the session. The data processing system 308 can receive the indication of interaction with the first interactive element via the UI element 500 and extend the session accordingly (e.g., postpone disconnection request to the server 306). The second interactive element can be selected by the user to deny session extension. The data processing system 308 can receive the indication of interaction with the second interactive element via the UI element 500 and terminate the session accordingly (e.g., transmit the session disconnection request to the server 306). Hence, the UI element 500 can be configured to extend the computing session to at least the start time of the event.

The UI element 500 can be presented to the client device 304 for a predetermined timeframe configurable by the administrator. If the UI element 500 expires (e.g., inactivity duration exceeds the predetermined timeframe), the data processing system 308 may determine to disconnect the session. Therefore, the data processing system 308 can transmit an indication (e.g., disconnection request) to disconnect the session to the server 306 or initiate the disconnection operation based on the UI element 500 expiration.

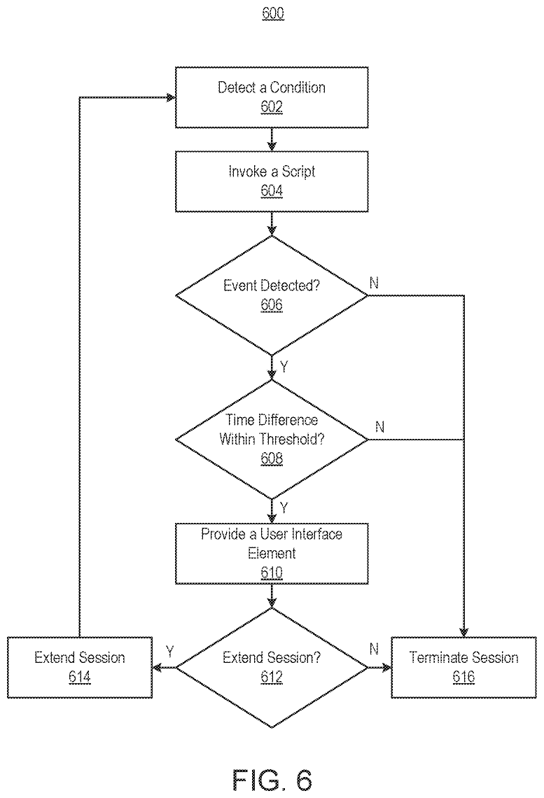

FIG. 6 illustrates an example flow diagram of a method 600 for inactivity logoff adjustment based on scheduled events. The example method 600 can be executed, performed, or otherwise carried out by one or more components of the system 300 (e.g., data processing system 308, client device 304, server 306, etc.), the computer 100, the cloud computing environment 214, or any other computing devices described herein in conjunction with FIGS. 1A-23. The method 600 can include detecting a condition, at ACT 602. At ACT 604, the method 600 can include invoking a script. At ACT 606, the method 600 can include determining whether at least one event is detected. At ACT 608, the method 600 can include determining whether a time difference is within a threshold. At ACT 610, the method 600 can include providing a UI element. At ACT 612, the method 600 can include determining whether to extend a session. At ACT 614, the method 600 can include extending the session. At ACT 616, the method 600 can include terminating the session.

Still referring to FIG. 6, and in further detail, at ACT 602, a data processing system (e.g., condition detector 312 of the data processing system 308) can detect a condition to terminate (e.g., termination condition), disconnect, or log off a computing session established between a client device (e.g., client device 304) and a server (e.g., server 306). The termination condition may be referred to as a disconnection condition or a logoff condition.

In some cases, the data processing system can establish the session for the client device. For example, the data processing system can be an intermediary for establishing the session. In another example, the data processing system can correspond to or be a part of the server hosting the session for the client device.

The data processing system can detect the termination condition at a first timestamp. The data processing system can detect the condition based on a duration of inactivity (e.g., inactivity duration) in the session. For example, the data processing system can receive a timeout value from one or more servers (e.g., servers remote from the data processing system). The data processing system may receive the timeout value via an authentication handshake process upon establishment of the session. The data processing system may retrieve the timeout value stored in the memory of the data processing system or stored remotely in the server. The timeout value can be established or configured by an administrator of the session different from a user that established the computing session (e.g., user of the client device). The timeout value can be configured for all sessions hosted by the server. The timeout value may be configured for one or more sessions established using a certain account identifier, such that sessions for certain account identifiers are configured with different timeout values.

Subsequent to receiving the timeout value, the data processing system can compare the inactivity duration in the session to the timeout value. If the inactivity duration is greater than or equal to the timeout value, the data processing system can detect the condition. Otherwise, if the inactivity duration is less than the timeout value, the data processing system may not detect the condition.

At ACT 604, the data processing system can invoke a script. The data processing system can invoke the script in response to the detection of the condition and prior to termination of the session. In various cases, the data processing system may invoke the script at a predetermined time interval (e.g., hourly or daily) before or after the detection of the condition. The script can be configured to access a data structure that maintains one or more events (e.g., scheduled events, tasks, reminders, meetings, or activities) to be performed by the user. The data processing system can maintain the data structure in a local database. Some of the events may be for execution in the computing session at their respective timestamps. Some other events may not be for execution in the computing session.

In some cases, the data structure may be maintained in remote storage(s), such as on one or more servers or cloud storage remote from the data processing system. In this case, the server may aggregate events (e.g., event information) from client devices, including the client device accessing the session established by the data processing system, associated with the same account identifier. For example, the user may be assigned an account identifier for authenticating to the computing session and for accessing one or more other resources (e.g., calendar, task list, email, or other applications including events with dates). The server can identify one or more client devices associated with the same account identifier and collect event information from the client devices. The server may aggregate events from other servers or remote storage maintaining a respective data structure storing events for account identifiers. For example, the server (e.g., a first server) can determine that the account identifier is associated with one or more data structures maintained on a second server. Accordingly, the first server can communicate with the second server to retrieve or obtain events associated with the same account identifier of the client device.

At ACT 606, the method 600 can include determining whether at least one event is detected. For example, in response to invoking the script, the data processing system can determine whether the account identifier of the user is associated with any of the events maintained or stored in the data structure (e.g., maintained in the data processing system or the server). If at least one event is identified, the data processing system can proceed to ACT 608. Otherwise, the data processing system can proceed to ACT 616.

At ACT 608, the method 600 can include determining whether a time difference is within a threshold. Upon identifying at least one event, the data processing system can determine the execution time or start time of the event. The execution time can correspond to a second timestamp subsequent to the first timestamp when the condition is detected. The execution time of the event can be a part of a parameter of the event. The data processing system can determine the time difference between the first timeframe and the second timeframe indicative of the duration from the detected condition until the execution of the event.

The data processing system can compare the time difference to the threshold configurable by the administrator. The threshold can represent an allowable extension time for the session or a time limit for postponing the session disconnection request. If the time difference is greater than the threshold, the data processing system can proceed to ACT 616. If the time difference is less than or equal to the threshold (e.g., within the threshold), the data processing system may proceed to ACT 610, as the parameter of the event satisfies a criterion (e.g., within allowable extension time for the session).

In some cases, to proceed to ACT 610, the data processing system can compare other parameters of the event to criteria configured for determining whether the event qualifies for an extension of the session. For example, the data processing system can determine whether the event is for execution in the session. The data processing system can determine that the session executes the event based on at least one keyword (e.g., part of the parameter) of the event. The keyword can be predefined or configured by the administrator. The keyword may correspond to an indication that the event is to be executed on at least one computing session established by the data processing system. For example, the keyword may indicate a scheduled meeting, call, resource(s) (e.g., files or applications) accessible via the session, among other terms indicative of an access to the session. If the event includes at least one of the predefined keywords, the data processing system can proceed to ACT 610.

Otherwise, if the event information does not include at least one predefined keyword, the data processing system may proceed to ACT 616. For example, the data processing system can identify a second event at a third timestamp responsive to detection (e.g., a second detection) of the condition. Based on the keyword of the event, the data processing system can determine that the second event is not configured for execution in the computing session. In this case, the keyword may indicate a reminder, appointment, off-work event, traveling event, or other types of events that do not involve usage of the computing session. Upon determining that the session is not configured for execution in the computing session, the data processing system can proceed to ACT 616 without provision of the user interface element configured to extend the session (e.g., without proceeding to ACT 610).

In some cases, the event may include a communication channel (e.g., part of the event parameter) between the session (e.g., first computing session) and a second computing session. The second session can be remote from the data processing system or the server hosting the first computing session. The communication channel can provide enable communication between the first computing session and the second computing session, such as a meeting link for a scheduled communication session. Hence, having a communication channel in the event can indicate that the second computing session can be accessed via the first computing session, e.g., the event for execution in the computing session. If the event includes the communication channel, the data processing system can proceed to ACT 610. If the event does not include the communication channel, the data processing system can proceed to ACT 616 or consider other parameters of the event.

At ACT 610, the method 600 can include providing a UI element to the client device based on the time difference less than or equal to the threshold. The UI element may be referred to as a notification, prompt, or message to the user. The UI element can be configured to extend the computing session to at least the second timestamp or the execution time of the event. For example, the UI element can include at least one interactive element and a description (e.g., indicating a confirmation is requested to extend the session). The data processing system can receive an indication of interaction with at least one interactive element via the UI element. Upon receiving the indication of interaction, the data processing system can proceed to ACT 612.

In some cases, the data processing system may determine the amount of time taken to execute the event based on the parameter of the event, such as start time, end time, or description of the event. For example, the data processing system can identify the second timestamp of the event as an initial reminder for the event to be executed in the session. Hence, the data processing system can determine the amount of time from the second timestamp taken to execute the event based on the parameter, for example, the execution time or remaining time until execution of the event. Upon determining the amount of time for execution, the data processing system can provide the UI element with a configuration (e.g., confirmation interactive element) to extend the session to at least a third timestamp that is the amount of time taken from the second timestamp to execute the event.

At ACT 612, the method 600 can include determining whether to extend a session. The data processing system can determine whether the user confirms or denies the session extension based on the indication of interaction. The response from the user via the UI element can correspond to an instruction to the data processing system (e.g., indication whether to extend the session). If the user confirms the extension (e.g., the data processing system receives an instruction to extend the session), the data processing system can proceed to ACT 614. If the user denies the extension, the data processing system can proceed to ACT 616. In some cases, if the data processing system is configured to automatically extend the session based on one or more keywords indicating the event execution in the session, the data processing system may proceed to ACT 614 without provision of or response to the UI element.

In some cases, in response to the provision of the UI element configured to extend the session to at least the second timestamp, the data processing system can initiate a counter. The counter can represent the remaining time until the expiration of the UI element (e.g., time limit for interacting with the UI element). Upon expiration of the counter without detection of an interaction with the UI element, the data processing system can proceed to ACT 616 to terminate the session.

At ACT 614, the method 600 can include extending the session. The data processing system can extend the session in response to receiving a confirmation for extension via the UI element. To extend the session, the data processing system may postpone or delay the transmission of a disconnection request to the server 306. The data processing system may perform other operations to extend the session, such as adjusting the timeout value, adjusting the inactivity duration (e.g., reducing the monitored inactivity duration), setting a second timeout value for transmission of the disconnection request, or initiating a countdown timer, among other operations discussed herein.

For example, the data processing system can prevent the termination of the computing session in response to the instruction from the client device. The data processing system can prevent the termination to at least the second timestamp to reduce an occurrence of an authentication process to re-establish the computing session to execute the event. Therefore, the data processing system may postpone the transmission of the disconnection request (e.g., termination request) of the session until at least the second timestamp or the execution time of the event.

In some cases, the data processing system can be configured to automatically extend the session based on the parameter of the event satisfying the criteria. For example, the data processing system can automatically extend the computing session to at least the second timestamp responsive to the time difference between the first and second timestamps less than the threshold. In further example, the data processing system can automatically extend the computing session in response to at least one keyword of the event matching a predefined keyword. In some cases, the data processing system can automatically extend the computing session based on the event including the communication channel. Once the session is extended, the data processing system may proceed to ACT 602, such as to detect another condition for terminating the session or proceed to terminate the session responsive to further inactivity in the session. The data processing system can proceed to ACT 602 after receiving an indication of activity in the session.

At ACT 616, the method 600 can include terminating the session. The data processing system can terminate the computing session responsive to the absence of any event associated with the account identifier of the user. If no event is associated with the account identifier, the data processing system may determine that there is no event for execution in the session. The data processing system can terminate the computing session based on time difference greater than the threshold. The data processing system can terminate the session based on at least one keyword of the event indicating that the event is not for execution in the session. The data processing system may terminate the session in response to the expiration of the counter associated with the presented UI element (e.g., no detection of interaction with the UI element). To terminate the session, the data processing system can transmit a request to terminate the session to the server hosting the session. In some cases, the data processing system can manage the session directly. Hence, the data processing system can initiate the termination process. The data processing system can perform other operations discussed herein to terminate the session.

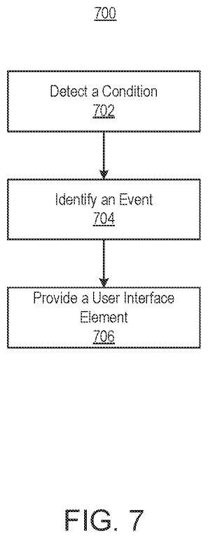

FIG. 7 illustrates an example flow diagram of a method 700 for providing a user interface element. The example method 700 can be executed, performed, or otherwise carried out by one or more components of the system 300 (e.g., data processing system 308, client device 304, server 306, etc.), the computer 100, the cloud computing environment 214, or any other computing devices described herein in conjunction with FIGS. 1A-2C. The method 700 can include detecting a condition, at ACT 702. At ACT 704, the method 700 can include identifying an event. At ACT 706, the method 700 can include providing a UI element.

Still referring to FIG. 7 in further detail, at ACT 702, one or more processors coupled to memory (e.g., data processing system 308, server 306, or client device 304) can detect a condition to terminate, at a first timestamp, a computing session established by the one or more processors. At ACT 704, the one or more processors can identify, responsive to detection of the condition and prior to termination of the computing session, an event for execution in the computing session at a second timestamp subsequent to the first timestamp. At ACT 706, the one or more processors can provide, based on a difference between the second timestamp and the first timestamp less than or equal to a threshold, a user interface element configured to extend the computing session to at least the second timestamp. Based on an instruction to extend the session from a client device, the one or more processors can proceed to extend the session. Based on an instruction to terminate the session, the one or more processors can proceed to terminate the session.

### Further Examples

The following examples pertain to further embodiments, from which numerous permutations and configurations will be apparent.

Example 1 includes a system, comprising: one or more processors, coupled to memory, to: detect a condition to terminate, at a first timestamp, a computing session established by the one or more processors; identify, responsive to detection of the condition and prior to termination of the computing session, an event for execution in the computing session at a second timestamp subsequent to the first timestamp; and provide, based on a difference between the second timestamp and the first timestamp less than or equal to a threshold, a user interface element configured to extend the computing session to at least the second timestamp.

Example 2 includes the subject matter of Example 1, wherein the one or more processors are further configured to: invoke, responsive to detection of the condition and prior to termination of the computing session, a script configured to access a data structure that maintains a plurality of events to be executed in the computing session at a plurality of timestamps.

Example 3 includes the subject matter of any of Examples 1 and 2, wherein the data structure is maintained by the one or more processors.

Example 4 includes the subject matter of any of Examples 1 through 3, wherein the data structure is maintained on one or more servers remote from the one or more processors, and the one or more servers are configured to aggregate the plurality of events from a plurality of client devices comprising a client device of the one or more processors associated with a same account identifier.

Example 5 includes the subject matter of any of Examples 1 through 4, wherein the one or more processors are further configured to: determine, based on a keyword of the event, that the computing session executes the event.

Example 6 includes the subject matter of any of Examples 1 through 5, wherein the one or more processors are further configured to: identify a second event at a third timestamp responsive to a second detection of the condition; determine, based on a keyword of the event, that the second event is not configured for execution in the computing session; and terminate the computing session without provision of the user interface element configured to extend the computing session.

Example 7 includes the subject matter of any of Examples 1 through 6, wherein the one or more processors are further configured to: detect the condition based on a duration of inactivity in the computing session being greater than or equal to a timeout value.

Example 8 includes the subject matter of any of Examples 1 through 7, wherein the one or more processors are further configured to: receive, from one or more servers remote from the one or more processors, upon establishment of the computing session with the one or more servers via an authentication handshake process, the timeout value for the computing session, the timeout value established by an administrator of the computing session that is different from a user that established the computing session.

Example 9 includes the subject matter of any of Examples 1 through 8, wherein the one or more processors are further configured to: determine, based on a parameter of the event, an amount of time taken to execute the event; and provide the user interface element with a configuration to extend the computing session to at least a third timestamp that is the amount of time taken from the second timestamp.

Example 10 includes the subject matter of any of Examples 1 through 9, wherein the one or more processors are further configured to: receive, via the user interface element, an instruction to extend the computing session to the at least the second timestamp; and prevent, responsive to the instruction, termination of the computing session to at least the second timestamp to reduce an occurrence of an authentication process to re-establish the computing session to execute the event.

Example 11 includes the subject matter of any of Examples 1 through 10, wherein the one or more processors are further configured to: initiate a counter responsive to provision of the user interface element configured to extend the computing session to at least the second timestamp; and terminate the computing session responsive to expiration of the counter without detection of an interaction with the user interface element.

Example 12 includes the subject matter of any of Examples 1 through 11, wherein the one or more processors are further configured to: automatically extend the computing session to at least the second timestamp responsive to the difference less than the threshold.

Example 13 includes the subject matter of any of Examples 1 through 12, wherein the event comprises a communication channel between the computing session and a second computing session remote from the one or more processors.

Example 14 includes a method, comprising: detecting, by one or more processors, coupled to memory, a condition to terminate, at a first timestamp, a computing session established by the one or more processors; identifying, by the one or more processors, responsive to detection of the condition and prior to termination of the computing session, an event for execution in the computing session at a second timestamp subsequent to the first timestamp; and providing, by the one or more processors, based on a difference between the second timestamp and the first timestamp less than or equal to a threshold, a user interface element configured to extend the computing session to at least the second timestamp.

Example 15 includes the subject matter of Example 14, comprising: invoking, by the one or more processors responsive to detection of the condition and prior to termination of the computing session, a script configured to access a data structure that maintains a plurality of events to be executed in the computing session at a plurality of timestamps.

Example 16 includes the subject matter of any of Examples 14 and 15, comprising: determining, by the one or more processors based on a keyword of the event, that the computing session executes the event.

Example 17 includes the subject matter of any of Examples 14 through 16, comprising: detecting, by the one or more processors, the condition based on a duration of inactivity in the computing session being greater than or equal to a timeout value.

Example 18 includes the subject matter of any of Examples 14 through 17, comprising: receiving, via the user interface element, an instruction to extend the computing session to the at least the second timestamp; and preventing, responsive to the instruction, termination of the computing session to at least the second timestamp to reduce an occurrence of an authentication process to re-establish the computing session to execute the event.

Example 19 includes a non-transitory computer-readable medium storing instructions that, when executed by one or more processors, cause the one or more processors to: detect a condition to terminate, at a first timestamp, a computing session established by the one or more processors; identify, responsive to detection of the condition and prior to termination of the computing session, an event for execution in the computing session at a second timestamp subsequent to the first timestamp; and provide, based on a difference between the second timestamp and the first timestamp less than or equal to a threshold, a user interface element configured to extend the computing session to at least the second timestamp.

Example 20 includes the subject matter of Example 19, wherein the instructions further comprise instructions to: invoke, responsive to detection of the condition and prior to termination of the computing session, a script configured to access a data structure that maintains a plurality of events to be executed in the computing session at a plurality of timestamps.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A system, comprising:
one or more processors, coupled to memory, to:
detect a condition to terminate, at a first timestamp, a computing session established by the one or more processors;
identify, responsive to detection of the condition and prior to termination of the computing session, an event for execution in the computing session at a second timestamp subsequent to the first timestamp; and
provide, based on a difference between the second timestamp and the first timestamp less than or equal to a threshold, a user interface element configured to extend the computing session to at least the second timestamp.

2. The system of claim 1, wherein the one or more processors are further configured to:
invoke, responsive to detection of the condition and prior to termination of the computing session, a script configured to access a data structure that maintains a plurality of events to be executed in the computing session at a plurality of timestamps.

3. The system of claim 2, wherein the data structure is maintained by the one or more processors.

4. The system of claim 2, wherein the data structure is maintained on one or more servers remote from the one or more processors, and the one or more servers are configured to aggregate the plurality of events from a plurality of client devices comprising a client device of the one or more processors associated with a same account identifier.

5. The system of claim 1, wherein the one or more processors are further configured to:
determine, based on a keyword of the event, that the computing session executes the event.

6. The system of claim 1, wherein the one or more processors are further configured to:
identify a second event at a third timestamp responsive to a second detection of the condition;
determine, based on a keyword of the event, that the second event is not configured for execution in the computing session; and
terminate the computing session without provision of the user interface element configured to extend the computing session.

7. The system of claim 1, wherein the one or more processors are further configured to:
detect the condition based on a duration of inactivity in the computing session being greater than or equal to a timeout value.

8. The system of claim 7, wherein the one or more processors are further configured to:
receive, from one or more servers remote from the one or more processors, upon establishment of the computing session with the one or more servers via an authentication handshake process, the timeout value for the computing session, the timeout value established by an administrator of the computing session that is different from a user that established the computing session.

9. The system of claim 1, wherein the one or more processors are further configured to:
determine, based on a parameter of the event, an amount of time taken to execute the event; and
provide the user interface element with a configuration to extend the computing session to at least a third timestamp that is the amount of time taken from the second timestamp.

10. The system of claim 1, wherein the one or more processors are further configured to:
receive, via the user interface element, an instruction to extend the computing session to the at least the second timestamp; and
prevent, responsive to the instruction, termination of the computing session to at least the second timestamp to reduce an occurrence of an authentication process to re-establish the computing session to execute the event.

11. The system of claim 1, wherein the one or more processors are further configured to:
initiate a counter responsive to provision of the user interface element configured to extend the computing session to at least the second timestamp; and
terminate the computing session responsive to expiration of the counter without detection of an interaction with the user interface element.

12. The system of claim 1, wherein the one or more processors are further configured to:
automatically extend the computing session to at least the second timestamp responsive to the difference less than the threshold.

13. The system of claim 1, wherein the event comprises a communication channel between the computing session and a second computing session remote from the one or more processors.

14. A method, comprising:
detecting, by one or more processors, coupled to memory, a condition to terminate, at a first timestamp, a computing session established by the one or more processors;
identifying, by the one or more processors, responsive to detection of the condition and prior to termination of the computing session, an event for execution in the computing session at a second timestamp subsequent to the first timestamp; and
providing, by the one or more processors, based on a difference between the second timestamp and the first timestamp less than or equal to a threshold, a user interface element configured to extend the computing session to at least the second timestamp.

15. The method of claim 14, comprising:
invoking, by the one or more processors responsive to detection of the condition and prior to termination of the computing session, a script configured to access a data structure that maintains a plurality of events to be executed in the computing session at a plurality of timestamps.

16. The method of claim 14, comprising:
determining, by the one or more processors based on a keyword of the event, that the computing session executes the event.

17. The method of claim 14, comprising:
detecting, by the one or more processors, the condition based on a duration of inactivity in the computing session being greater than or equal to a timeout value.

18. The method of claim 14, comprising:
receiving, via the user interface element, an instruction to extend the computing session to the at least the second timestamp; and
preventing, responsive to the instruction, termination of the computing session to at least the second timestamp to reduce an occurrence of an authentication process to re-establish the computing session to execute the event.

19. A non-transitory computer-readable medium storing instructions that, when executed by one or more processors, cause the one or more processors to:
detect a condition to terminate, at a first timestamp, a computing session established by the one or more processors;
identify, responsive to detection of the condition and prior to termination of the computing session, an event for execution in the computing session at a second timestamp subsequent to the first timestamp; and
provide, based on a difference between the second timestamp and the first timestamp less than or equal to a threshold, a user interface element configured to extend the computing session to at least the second timestamp.

20. The computer-readable medium of claim 19, wherein the instructions further comprise instructions to:
invoke, responsive to detection of the condition and prior to termination of the computing session, a script configured to access a data structure that maintains a plurality of events to be executed in the computing session at a plurality of timestamps.
